(19) United States
(12) Patent Application Publication
(10) Pub. No.: US 2026/0217994 A1
(43) Pub. Date: Jul. 30, 2026

(54) RESIN COMPOSITION FOR PAINT AND PAINT

(71) Applicant: SOMAR CORPORATION, Tokyo (JP)

(72) Inventor: Naoki Sakazume, Tokyo (JP)

(21) Appl. No.: 19/145,385

(22) PCT Filed: Dec. 13, 2023
(86) PCT No.: PCT/JP2023/044552

§ 371 Date: Jul. 2, 2025

(30) Foreign Application Priority Data
Jan. 26, 2023 (JP) 2023-010034

(51) Int. Cl. C09D 7/62; C09D 7/40; C09D 131/04

(52) U.S. Cl. CPC C09D 7/62; C09D 7/69; C09D 131/04

(57) ABSTRACT

A resin composition for paint, which enables formation of a membrane with high designability and excellent abrasion resistance. Here, (A) indicates a resin component, (A1) indicates a polyvinyl acetal resin, (B) indicates a black material and (B1) indicates a composite of a black pigment and a resin. The resin composition includes at least (A) and (B). (A) has 90% by mass or more of (A1). (B) has 90% by mass or more of (B1) having a particle diameter of 2 μm or more and 6 μm or less, and a mass ratio of (B) with respect to a resin solid content of (A):1 is 7 or more and 14 or less.

### TECHNICAL FIELD

The present invention relates to a resin composition for paint and a paint comprising the same.

### BACKGROUND ART

In electronic devices, such as a smartphone, tablet and personal computer, a black membrane is sometimes provided to a part or all of its chasses (regardless of an outer surface or inner surface) and a part of a not-viewed surface (e.g. a frame part) of a cover glass to be arranged and fixed to a viewing-surface side of a touch panel for the purpose of enhancing designability thereof, hiding its internal wiring, etc. and blocking lights, etc. In recent years, such demand is also found in a part (e.g. an outer frame of a lens) or all of electronic device components, such as a lens mounted on a variety of camera units, a model for building, such as a plastic model, or parts for building a model in a model building kit.

The patent document 1, for example, discloses a technique of forming a membrane on a chassis of a portable electronic device, such as a smartphone, by screen printing of an insulation material directly thereon or by in-mold molding to obtain a membrane-forming film having screen printing thereon.

### RELATED ART DOCUMENTS

### Patent Document

Patent Document 1: Japanese Patent Unexamined Patent Publication (Kokai) No. 2007-285093

### SUMMARY OF THE DISCLOSED SUBJECT MATTER

However, along with demands on enhancing designability in industrial products, there are more demands for providing a black membrane with higher designability (e.g. an uneven membrane) to those products. There are demands also for securing an abrasion resistance during producing a membrane (film formation) and when handing them.

The present invention was made in consideration with the circumstances above. The present invention has an object thereof to provide a resin composition for paint and the paint capable of forming a membrane with high designability and an excellent abrasion resistance.

The present inventors conducted studies diligently and succeeded in increasing a compounding amount of a black material in a membrane to be formed by fulfilling the requirement (a) below (namely, to contain a specific composite having a particle diameter in a predetermined range in the black material). As a result, they found that it is effective for forming a membrane with high designability, which realizes more-than-ever super low reflectance (less than 1.5%) and a super low L value (less than 15) in addition to low glossiness (less than 1%). Furthermore, they also found that, by fulfilling the requirement (b) below (namely, to contain a specific resin in a resin component), it is effective for forming a membrane with a high abrasion resistance to realize high membrane strength even a relative compounding amount is low with respect to a black material in a membrane to be formed.
(a) To use a black material containing a specific composite (a composite of a black pigment and a resin) having a particle diameter in a predetermined range.
(b) To use a resin component comprising a specific resin (a polyvinyl acetal resin).

The working mechanism of expressing the phenomena as above is not clear, however, it is considered that as a reflective effect that high membrane strength can be expressed when containing the specific resin in resin components even if comprising a small amount, a relative compounding amount of a black material including the specific composite can be increased, consequently, designability of a membrane is enhanced.

Based on the newly acquired knowledge as above, the present inventors completed the invention as provided below and attained the object above. Below, (A) indicates a resin component, (A1) indicates a polyvinyl acetal resin, (B) indicates a black material, (B1) indicates a composite of a black pigment and a resin, and (C) indicates a diluent solvent.

According to the present invention, there is provided a resin composition for a paint comprising at least (A) and (B), wherein
(A) comprises 90% by mass or more of (A1)
(B) comprises 90% by mass or more of (B1) having a particle diameter of 2 μm or more and 6 μm or less and a mass ratio of (B) with respect to (A):1 is 7 or more and 14 or less,
(A) is a resin component,
   (A1) is a polyvinyl acetal resin
(B) is a black material, and
   (B1) is a composite of a black pigment and a resin.

The composition above may include the mode below.
It is preferable that (B1) comprises an acrylic resin particle containing carbon black therein.

According to the present invention, there is provided
a paint comprising the composition above and (C),
wherein viscosity at 25° C. measured by a B-type viscometer is 1 mPa·s or more and 2000 mPa·s or less.

The paint above may include the following modes.
It may be used for applying to model parts.
It may be used for applying to camera parts.
It may be used for applying in the spray coating method.
It may be used for applying in the dip coating method.
It may be used for applying in the dispenser method.
It may be used for applying by a brush painting method.

According to the present invention, there is provided
a membrane formed from the paint above, wherein
an outermost surface of a plane formed with the membrane has glossiness of less than 1% against an incident light at an angle of 60°, reflectance of less than 1.5% against a light having a wavelength of 550 nm, and an L value of less than 15 in the CIELAB color space system by the SCE method.

The membrane above may include the following modes.
In the case where a light-shielding characteristic when transmitting a light is required to the membrane, an outermost surface of a plane formed with the membrane preferably has an optical density of 2 or more.

According to the present invention, there are provided a resin composition for paint, which enables formation of a membrane having high designability and an excellent abrasion resistance, and a paint thereof.

### EXEMPLARY MODE FOR CARRYING OUT THE DISCLOSED SUBJECT MATTER

Below, the best modes for carrying out the invention will be explained, however, the present invention is not limited to the modes below and also includes those obtained by suitably modifying or improving the modes explained below based on ordinary knowledge of persons skilled in the art within the scope of the present invention.

As to a range of value in the present specification, an uppermost value or a lowermost value described in certain value ranges may be replaced by values indicated in the EXAMPLES below.

In the present specification, when there are a plurality of kinds of substances falling under each component in a composition, a content ratio or a content in each component in the composition indicates a content ratio or a content of a total of the plurality of kinds of substances being in the composition unless otherwise mentioned.

### <Resin Composition for Paint>

A resin composition for paint according to one mode of the present invention (hereinafter, also simply referred to as “a composition”) comprises (A) a resin component and (B) a black material. (A) comprises (A1) a polyvinyl acetal resin and (B) comprises (B1) a composite of a black pigment and a resin, having a particle diameter of a predetermined range.

A membrane formed form a composition comprising (A) and (B) has low glossiness (less than 1%) comparing with a membrane formed from a resin composition for paint in the related art and, in addition, it realizes super low reflectance (less than 1.5%) and super low L value (less than 15) than before and, moreover, exhibits high membrane strength. The reason why is not very clear but, when (A) comprises (A1) having characteristics of being strong and having plasticity and a crosslinking property itself, high membrane strength is realized only with a small content in a membrane to be formed. It is considered that as a reflective effect thereof (the fact that a small content is sufficient), a compounding amount of (B) comprising (B1) can be increased relatively in the membrane and, consequently, low glossiness, super low reflectance and a super low L value are expressed effectively.

### —(A)—

(A) to be used for forming a composition is a fixing material to a coating surface and also is a binder for (B). Specifically, it includes a thermoplastic resin. As a thermoplastic resin, for example, a polyacrylic ester resin, polyvinyl chloride resin, polyvinyl acetal resin, styrene-butadiene copolymer resin, etc. may be mentioned. Among them, in terms of realizing low glossiness, super low reflectance and a super low L value of a surface of a membrane to be formed and membrane strength, (A1) a polyvinyl acetal resin is contained preferably. A thermoplastic resin may be used as one kind alone or in combination of two or more kinds.

As a result that a thermoplastic resin contained in (A) comprises (A1), flexibility and strength are given to a film to be formed. Moreover, since it has a crosslinking property itself, high membrane strength (an abrasion resistance) can be realized even a small amount is compounded in a composition (also in a membrane).

(A1) is a polymer having a component comprising an acetal group in its molecular and is preferably a polymer comprising a constituting unit having an acetal group and a constituting unit having a hydroxy group. As (A1), for example, polyvinyl formal, polyvinyl acetoacetal, polyvinyl propyral and polyvinyl butyral, etc. may be mentioned. More specifically, a polymer expressed by the formula (1) below is preferable.

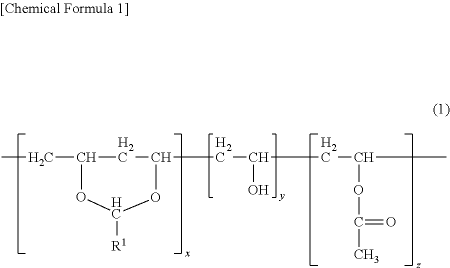

In the formula (1), R¹ indicates a hydrogen atom or a 1-20C alkyl group, x indicates a content (mol %) of a constituting unit having a vinyl acetal group, which is indicated by a total content (mol %) of a constituting unit derived from acetalized vinyl alcohol, y indicates a content (mol %) of a constituting unit derived from vinyl alcohol, and z indicates a content (mol %) of a constituting unit derived from vinyl acetate, wherein x and y are larger than 0 and z may be 0.

As R¹, a hydrogen atom or a 1-10C alkyl group is preferable, a 1-6C alkyl group is more preferable, and a propyl group is most preferable. Namely, as (A1), a polyvinyl butyral resin having a constituting unit of R¹, which is a propyl group, is most preferable.

A polyvinyl butyral resin can be obtained by bringing polyvinyl alcohol (PVA) react with butyl aldehyde under an acidic condition to cause acetalization. When acetalizing PVA, it is difficult to acetalize PVA completely, so that partially a hydroxy group resides irreversibly. Also, PVA is normally produced by saponifying polyvinyl acetate, however, a small amount of an acetyl group often resides in the saponifying step in the PVA production, so that generally an acetyl group and hydroxy group reside partially in a polyvinyl butyral resin in an irreversible way.

A glass transition temperature (Tg) of a polyvinyl butyral resin may be 40° C. or more and 130° C. or less and preferably 60° C. or more and 120° C. or less in terms of a heat resistance property. When a glass transition temperature (Tg) is in the range as such, advantages that strength of a coated membrane improves, etc. can be expressed when coated to be a membrane. A glass transition temperature (Tg) can be obtained by measuring a change of a calorific value by the differential scanning calorimetry (DSC method).

In (A1), x, namely a content of a constituting unit having an acetal group (hereinafter, also referred to as “an amount of an acetal group” or “an acetalized degree”), may be preferably 60 mol % or more, more preferably 65 mol % or more and furthermore preferably 70 mol % or more in terms of smoothness on a surface of a coated membrane when formed to be a coated membrane, and it may be preferably 95 mol % or less, more preferably 90 mol % or less and furthermore preferably 85 mol % or less in terms of dispersibility of a black material in a composition.

An amount of an acetal group (x) is a mol fraction obtained by dividing an amount of an ethylene group bonded with an acetal group by a total amount of an ethylene group as a main chain and corresponds to a content (mol %) of a constituting unit having an acetal group. An amount of an ethylene group bonded with an acetal group (a butyral group, in particular) may be measured by using “Testing Methods for Polyvinyl Butyral” based on JIS K6728.

In (A1), y therein, namely a content of a constituting unit having a hydroxy group (hereinafter, also referred to as “an amount of a hydroxy group”), may be preferably 10 mol % or more, more preferably 15 mol % or more and furthermore preferably 20 mol % or more and preferably 50 mol % or less, more preferably 45 mol % or less and furthermore preferably 40 mol % or less in terms of adhesiveness of a coated membrane with an object to be coated when formed to be a coated membrane.

When (A1) contains a constituting unit having an acetyl group, a content (hereinafter, also referred to as “an amount of an acetyl group”) thereof may be preferably 0.0001 mol % or more, more preferably 0.001 mol % or more and preferably 15 mol % or less, more preferably 10 mol % or less and furthermore preferably 8 mol % or less in terms of increasing a content of a black material.

A molecular weight of (A1) is not particularly limited but preferably 8000 or more, more preferably 10000 or more, furthermore preferably 15000 or more, and particularly preferably 20000 or more and preferably 300000 or less, more preferably 200000 or less and furthermore preferably 150000 or less in terms of membrane strength when formed to be a coated membrane. A molecular weight of (A1) can be obtained by calculation.

In terms of improving a coagulation ability of a coated membrane when formed to be a coated membrane, (A1) may comprise a modified polyvinyl acetal resin comprising one or more kinds selected from a constituting unit having an imine structure, a constituting unit having an acidic modified group and a constituting unit having an amino group or amide structure.

When comprising a constituting unit having an imine structure (a structure having a C═N bond), a content thereof is preferably 0.1 mol % or more, more preferably 1 mol % or more and preferably 20 mol % or less and more preferably 15 mol % or less. As an acidic modified group, a carboxy group, sulfonic acid group, maleic acid group, phosphate group, etc. and salts thereof may be mentioned. When comprising a constituting unit having an acid modified group, a content thereof is preferably 0.01 mol % or more, more preferably 0.05 mol % or more and preferably 5 mol % or less and more preferably 3 mol % or less. A content of a constituting unit having an imine structure and a constituting unit having an acid modified group may be measured, for example, by NMR. In a modified polyvinyl acetal resin, an imine structure, acid modified group, an amino group or an amido structure may bond directly with carbon constituting a main chain or a side chain of a modified polyvinyl acetal resin or may bond via a linking group, such as an alkylene group.

(A1), a molecular weight, structure and an amount of a hydroxy group, etc. of a modified polyvinyl acetal resin may be adjusted properly by a polymerization degree of PVA to be used and a condition of acetalizing reaction.

In (A1), it is preferable that a total of x, y and z in the formula (1) above is 100 mol %.

To raise examples of a polyvinyl acetal (butyral) resin, products by Sekisui Chemical Co., Ltd., which are S-LEC BL (low molecular weight type) series: BL-1, BL-1H, BL-S, BL-2H; BM (medium molecular weight type) series: BM-1, BM-2 (Z), BM-5, BM-S(Z); BH (high molecular weight type) series: BH-S, BH-A; BX (heat-resistant type) series: BX-1, BX-5 (Z); KS (high heat-resistant type) series: KS-6Z, KS-5Z, etc., and products by Kuraray Co., Ltd., which are MOWITAL series, etc. may be mentioned.

The (A1) above may be used one kind alone or in combination of two or more kinds.

(A) may comprise a thermosetting resin together with (A1). When (A) comprises a thermosetting resin, performance of adhesiveness between a coated membrane and an object to be coated is expected to be improved when formed to be a coated membrane. As a thermosetting resin, for example, an acrylic resin, urethane-based resin, phenol-based resin, melamine-based resin, urea-based resin, diaryl phthalate-based resin, unsaturated polyester-based resin, epoxy-based resin, and alkyd-based resin, etc. may be mentioned. A thermosetting resin may be used as one kind alone or in combination of two or more kinds. When (A) comprises a thermosetting resin, a weight ratio of a thermosetting resin in (A) with respect to a resin solid content of (A1): 1 may be preferably 0.1 or more, more preferably 0.5 or more and preferably 1.5 or less and more preferably 1 or less in terms of adhesiveness between a coated membrane and an object to be coated when formed to be a coated membrane.

A content (total amount) of (A1) in (A) is preferably 90% by mass or more and more preferably 95% by mass or more. The upper limit thereof is not particularly limited and is 100% by mass. Namely, in one mode, 100% by mass of (A) may comprise (A1) in an amount of preferably 90% by mass or more.

A content (a total amount) of (A) is not particularly limited but, when considering a blending balance with other components, it may be preferably 1% by mass or more, more preferably 5% by mass or more and, in terms of strength of a coated membrane when formed to be a coated membrane, it may be preferably 25% by mass or less and more preferably 20% by mass or less with respect to a total amount (100% by mass) of a total solid content of the composition.

### —(B)—

(B) to be used for forming a composition comprise (B1) a composite of a black pigment and a resin.

As a resin constituting a composite with a black pigment, those having a water-insoluble property are used. As such resins, for example, an epoxy resin, acrylic resin, urethane resin, styrene resin, ethylene resin, phenol resin, urea resin, amide resin, melamine resin and benzoguanamine resin, etc. may be mentioned. Among them, in terms of dispersibility in a composition, an acrylic resin and urethane resin are preferable and an acrylic resin is more preferable.

They may be used alone or in combination of two or more kinds.

Note that by putting a resin name before a word “beads”, a name of a resin particle may be partially omitted. For instance, a resin particle made of an acrylic resin may be referred to as acrylic beads in some cases.

A black pigment constituting a composite with a resin is not particularly limited but carbon black (hereinafter, also simply referred to as “CB”) is preferably used because an effect of making the composite black is significant with it and it is advantageous in terms of the price, as well. When using CB, a membrane to be formed is colored, so that the effect of preventing reflection improves furthermore and a preferable antistatic effect can be obtained, as well.

As a form of a composite of a black pigment and a resin, for example, any of (1) a form of covering the black pigment with a resin (including a form of containing a black pigment in a resin particle), (2) a form of bonding a resin with a surface or inside of the black pigment, and (3) a form of adhering a resin to a surface or inside of the black pigment, or a form of combining those may be mentioned.

As a means of covering a surface of a black pigment with a resin, for example, a microcapsule method, more specifically, an interfacial polymerization method, in-situ polymerization method, in-liquid cured coating method (Orifice method), a phase separation method from a solution and in-liquid drying method, etc. may be mentioned. Besides the microcapsule methods, there is a method of bonding or adhering resin to dispersed black pigment, as well. An example of this is a form of covering a surface of a pigment as a core with numerous colloidal resin particles. When applying a coloring agent obtained by covering a black pigment as a core with numerous colloidal resin particles, it is desired that a size of the resin particles around the pigment core is sufficiently small. Furthermore, it is desired that the colloidal resin particles cover a pigment core leaving almost no gap. However, it is not to exclude those that a pigment core is exposed directly to the outside.

Also, (B1) may be obtained by bonding a pigment with a resin having approximately the same size as the pigment particle. Alternately, by kneading a black pigment or black dye with a thermoplastic resin or thermosetting resin and pulverizing, the black pigment, etc. can be compounded with a resin.

In one mode, in terms of improving dispersibility in a composition, a compounding mode is preferably the mode (1), which includes the mode of a resin particle containing a black pigment therein. Comparing with the case of mixing a pigment having a small diameter directly in a composition, a resin particle containing a black pigment therein contributes to an improvement of dispersibility because the pigment is contained in the resin particle having a larger diameter and an aggregate is hard to be caused in the composition.

A content of a pigment (CB in particular) in (B1) is preferably 1% by mass or more, more preferably 5% by mass or more, furthermore preferably 10% by mass or more, and preferably 50% by mass or less, more preferably 40% by mass or less and furthermore preferably 30% by mass or less.

A particle diameter of (B1) is preferably 2 μm or more, more preferably 3 μm or more, and preferably 8 μm or less, more preferably 6 μm or less, and furthermore preferably 4 μm or less. When a particle diameter is too small, aggregates increase in a composition, so that it tends to become difficult to be dispersed. When a particle diameter is too large, the coloring effect tends to decline.

Note that a particle diameter of (B1) is a value of a particle diameter when an integrated value expressed by an integration (cumulation) percentage becomes 50% (D50) in a particle diameter distribution.

A shape of (B1) is not particularly limited but sphere is preferable in terms of a matting property. In order to realize lower glossiness, lower reflectance and a lower L value on a surface of a membrane to be formed, it is preferable to use particles having a narrow particle distribution (a CV (Coefficient of Variation) value is, for example, 15 or less) (a sharp product). The CV value is a numerically expressed degree of spread of a particle diameter distribution (variation of particle diameters) with respect to an average value of particle diameters (calculated average particle diameter). When using a particle as above, it is contained uniformly in a membrane and fine unevenness is formed on the membrane surface, so that furthermore lower glossiness, lower reflectance and a lower L value on the membrane surface can be realized easily.

Also, in order to reduce a glossiness degree furthermore on the membrane surface to be formed, a particle in an indefinite shape may be used as (B1), as well. When using a particle in an indefinite shape as (B1), lights refract repeatedly inside and surface of (B1) when formed into a membrane, consequently, a glossiness on the membrane surface can be furthermore reduced.

As (B1), market-available products can be used. As those including urethane beads, for example, Art Pearl C800 black (a particle diameter 6.5 μm, CB content 7.5%, by Negami Chemical Industrial Co., Ltd.), etc. may be mentioned. As those including acrylic (acrylic copolymer) beads, for example, Art Pearl GR-004BK (a particle diameter 3 to 5 μm, CB content 35 to 39%, by Negami Chemical Industrial Co., Ltd.) and RUBCOULEUR 224 (SMD) black (an average particle diameter 2 to 3 μm, CB content 18%, by Dainichiseika Color & Chemicals Mfg. Co., Ltd.), etc. may be mentioned.

A content of (B1) in (B) is preferably 90% by mass or more and more preferably 95% by mass or more. An upper limit thereof is not particularly limited and is 100% by mass. Namely, in one mode, (B1) may be included preferably by 90% by mass or more in 100% by mass of (B).

In one mode, a mass ratio of (B) with respect to a resin solid content in (A):1 is 7 or more, preferably 8 or more, more preferably 9 or more and preferably 14 or less and more preferably 12 or less. When compounding (B) in these mass ratio ranges, it is possible to realize low glossiness, low reflectance and a low L value while maintaining strength of a coated membrane.

A content (total amount) of (B) is, with respect to a total amount (100% by mass) of all solid content of a composition, for example, 60% by mass or more, preferably 65% by mass or more, more preferably 75% by mass or more and, for example, 90% by mass or less, preferably 85% by mass or less and more preferably 80% by mass or less. When a total amount of (B) is less than 60% by mass, disadvantages of an increase of glossiness and a short of optical concentration arise, while when exceeds 90% by mass, an amount of (A) in a formed membrane decreases relatively, as a result, a disadvantage that a membrane falls off from an object to be coated may occur in some cases.

### —(D) Optional Components—

Other than the components ((A) and (B)) above, a composition may comprise (D) as long as not hindering the effects of the present invention. As (D), for example, a leveling agent, thickener, pH adjusting agent, lubricant, dispersant, defoaming agent, curing agent and reaction catalyst, etc. may be mentioned. A compounding amount of (D) in the composition is, with respect to 100 parts by weight of (A), preferably 0 to 100 parts by weight and more preferably 0 to 30 parts by weight.

Particularly by compounding a curing agent, crosslinking of (A) can be accelerated by using a hydroxy group contained in (A1). As a curing agent, which reacts with a hydroxy group, for example, epoxy compounds, methylol compounds, isocyanate compounds and titanium chelate compounds, etc. may be mentioned. Among them, isocyanate compounds are particularly preferable.

As isocyanate compounds used preferably as a curing agent, a compound having two or more isocyanate group in a molecule may be used suitably. For example, at least one of aromatic polyisocyanate, aliphatic polyisocyanate, alicyclic polyisocyanate, aromatic-aliphatic polyisocyanate and derivatives thereof may be mentioned. Here, aromatic-aliphatic polyisocyanate indicates polyisocyanate having a structure that an isocyanate group bonds with an aromatic ring via an aliphatic carbon atom.

As aromatic polyisocyanate, 2,4-toluene diisocyanate, 2,6-toluene diisocyanate or a mixture of 2,4-toluene diisocyanate and 2,6-toluene diisocyanate, 1,5-naphtharene diisocyanate, tolidine diisocyanate, p-phenylene diisocyanate, triphenylmethane triisocyanate, tris(isocyanatophenyl) thiophosphate, etc. may be mentioned. As aliphatic polyisocyanate, for example, hexamethylene diisocyanate, trimethylene diisocyanate, tetramethylene diisocyanate, pentamethylene diisocyanate, trimethyl hexamethylene diisocyanate, etc. may be mentioned. As alicyclic polyisocyanate, for example, isophorone diisocyanate, dicyclohexylmethane diisocyanate, 1,3-bis(isocyanatomethyl)cyclohexane, bis(isocianatomethyl) norbornane, etc. may be mentioned.

As aromatic-aliphatic polyisocyanate, for example, xylylene diisocyanate, tetramethyl xylylene diisocyanate, ω,ω′-diisocyanate-1,4-diethylbenzen, etc. may be mentioned. As derivatives of polyisocyanate compounds, trimer, dimer, pentamer or other multimers, such as isocyanurate of the isocyanate compounds mentioned above, an adduct product obtained by a reaction of the isocyanate compounds with a polyol compound, such as trimethylol propane, etc., allophanate product, buret compound or other modified polyisocyanate, etc. may be mentioned.

In terms of adhesiveness between a coated membrane and an object to be coated when formed to be a membrane, it is preferable to have a structure that a nitrogen atom of an isocyanate group is bonded with an aliphatic carbon atom, and at least one of aliphatic polyisocyanate, alicyclic polyisocyanate, aromatic-aliphatic polyisocyanate and derivatives of those may be used preferably. Among them, in terms of adhesiveness between a coated membrane and an object to be coated when formed to be a membrane and membrane strength, an isocyanurate of aliphatic polyisocyanate, xylylene diisocyanate and modified-polyisocyanates of these may be used preferably.

Curing agents able to be compounded in the paint may be used one kind alone or in combination of two or more kinds.

When blending a curing agent in a composition, a ratio thereof is preferably 10 to 70% by mass with respect to 100% by mass of (A). By adding a curing agent in the range above, a membrane having a higher abrasion resistance and exhibiting higher membrane strength can be obtained, and optical characteristics on the membrane surface can be maintained over a long period of time.

When compounding a curing agent in a composition, a reaction catalyst may be also used in order to accelerate a reaction of (A) with a curing agent. As a reaction catalyst, ammonia and ammonium chloride, etc. may be mentioned. A ratio when compounding a reaction catalyst in a composition is preferably 0.1 part by weight or more and 10 parts by weight or less with respect to 100 parts by weight of a curing agent.

A composition according to one mode of the present invention may be prepared (produced) by adding (A), (B) and, when needed, (D), mixing and agitating. An order of mixing the respective components is not particularly limited and it is sufficient if those components are mixed uniformly.

### <Paint>

A paint according to one mode of the present invention is used for forming on a coating surface a membrane formed from the composition explained above and comprises the composition above and (C) a diluent solvent.

### —(C)—

(C) to be used for forming a paint is compounded for the purpose of dissolving (A) and adjusting viscosity of the entire composition. By using (C), uniformity of the paint is improved. Moreover, viscosity of the paint can be adjusted properly and operability of the paint and uniformity of the application thickness can be improved when forming a membrane on a coating surface, so that it largely contributes to enhance designability of a finally obtained product.

(C) is not particularly limited as long as it is a solvent capable of dissolving (A) and adjusting viscosity of a paint. As (C), water, an organic solvent and a mixture of water and an organic solvent may be mentioned. As an organic solvent, for example, methyl ethyl ketone, toluene, propylene glycol monomethyl ether acetate, ethyl acetate, butyl acetate, methanol, ethanol, isopropyl alcohol and butanol, etc. may be used. (C) may be used as one kind alone or in combination of two or more kinds. A compounding amount may be set properly in order to adjust a concentration of a solid content of a paint.

A proper viscosity range of a paint varies depending on an application method, so that it cannot be said definitely, but viscosity at 25° C. by a B-type viscosimeter is 1 mPa·s or more and 2000 mPa·s or less or so. For example, in the case where the application method is a spray coating method, it is preferable to set to 1 mPa·s or more and 50 mPa·s or less or so. In the case of a dip coating method, 20 mPa·s or more and 500 mPa·s or less is preferable. In the case of a dispenser method, 10 mPa·s or more and 300 mPa·s or less or so is preferable. In the case of a method using a paintbrush or a brush (brush painting method), 100 mPa·s or more and 2000 mPa·s or less or so is preferable.

In the case of a spray coating method, when viscosity of a paint is too low, there is a possibility that a membrane having a thickness capable of bringing out predetermined performance cannot be formed in some cases. When viscosity of a paint is too high, it is liable to cause disadvantages that a liquid does not come out from a nozzle or it cannot be atomized even if it could come out, etc. In the case of a dip coating method, when viscosity of a paint is too low, liquid dripping becomes intense and unevenness arises, so that there is a possibility that a preferable membrane cannot be formed in some cases. When viscosity of a paint is too high, drainage becomes poor when pulling out an object to be coated from a paint, and burr, etc. may be caused or it is liable that a shape of a surface of a coated membrane becomes flat, which results in causing glossiness in some cases.

In the case of a dispenser method, when viscosity of a paint is too low, splash and dripping of the liquid are caused so that there is a possibility that a paint is applied to parts, on which a paint should not be applied, in some cases. When viscosity of a paint is too high, a liquid does not come out from a nozzle or, even if it comes out, there is a possibility that a shape of a surface becomes flat, which results in causing glossiness in some cases. In the case of a brush painting method, when viscosity of a paint is too low, a disadvantage of liquid dripping may arise. When viscosity of a paint is too high, a disadvantage that the liquid becomes faint may arise.

Viscosity of a paint differs depending on components contained in a composition in a paint, namely, kinds and molecular weights, etc. of (A) and (B) used for forming the composition, and it also differs depending on a kind and molecular weight, etc. of an optional component when an optional component is compounded in addition to the (A) and (B) above, however, it can be adjusted easily by determining an amount of (C) in the paint properly.

The paint according to one mode of the present invention may be one-liquid type or two-liquid type. When compounding a curing agent, the paint according to one mode may be two-liquid type with, for example, a first liquid comprising components other than a curing agent and a second liquid comprising the curing agent.

The paint according to one mode may be used for applying to parts for building a model, applying to camera parts, applying in a spray coating method, applying in a dip coating method, applying in a dispenser method or applying in a brush painting method.

### <Application Method and Object to be Coated>

A membrane according to one mode of the present invention is formed by applying the paint explained above to an object to be coated to form a coating film, then, drying the coating film.

An application method of the paint may be a spray coating method (for example, an air spray method, airless spray method and electrostatic spray method, etc.). When using a spray coating method, even if a surface of an object to be coated has a protruded or uneven portion, etc., a membrane with a uniform thickness and specific performance can be formed over the entire surface.

As an application condition using a spray coating method, preferably a caliber of a spray gun is 0.2 to 1.2 mm or so, an amount of a spraying liquid is 0.2 to 10 (g/minute) or so, a shortest distance between a spray gun and an application surface is 30 to 500 mm or so, an application rate is 30 to 300 (mm/second) or so, a superimposing pitch is 1.5 to 10 mm or so, and a pressure of an atomizing air is 0.03 to 0.2 MPa or so. As the number of the spray guns, besides operating with a single gun, a plurality of guns may be arranged in accordance with a size of an object to be coated in terms of improving application efficiency.

After applying the paint above to a surface of an object to be coated, a solvent is removed by drying so as to form a membrane. In accordance with need, the coating film may be irradiated by an UV light or EB light.

In the case where the paint comprises a curing agent, the coating film may be heated to be cured. The heating condition may be adjusted properly depending on a thickness of a coating film before heating, a heat-resistance property of an object to be coated and a kind of (C) to be used, etc. The heating condition is, to raise an example, at 70° C. or more and 150° C. or less for 1 minute or more and 30 minutes or less and preferably 100° C. or more and 130° C. or less for 2 minutes or more and 10 minutes or less.

Besides the case of a spray coating method, application of the paint may be, for example, a dip coating (immersion) method, a dispenser method and a brush painting method.

In the case where application of the paint is by a brush painting method, a thickness of a membrane to be formed on a coating is liable to vary depending on where to be formed, however, performance of a membrane to be obtained becomes equivalent to the cases by other application methods. The reason thereof is not clear but it is considered that unevenness is formed as a result of comprising a suitable amount of pigment.

An object to be applied with a paint (object to be coated) is not particularly limited as long as the object has a hard surface, for example, made of glass, a resin, metal, ceramic and wood, etc. A shape of the object to be coated is also not particularly limited, and a plate shape, (hollow) cylinder shape and film shape, etc. may be mentioned.

As an object to be coated, for example, the followings may be mentioned.
electric/electronic devices, such as a cellular phone, smartphone, tablet, personal computer, peripheral appliances of personal computer (a keyboard, printer and external drive, etc.), watch, audio appliances, and a variety of office automation appliances
home electric appliances, such as a refrigerator, vacuum cleaner, microwave, television, and recording appliances
furniture and wooden products, such as stairs, floor, table, chair and closet
a variety of building materials, such as flooring, and inner wall/outer wall of building
vehicles, such as automobiles and motorcycles, and components thereof: specifically, a body of vehicle, interiors (a meter panel, dashboard, handle, sensing camera bracket (installed on an upper portion, etc. of inside of a front glass), head-up display (HUD), etc.), bumper, spoiler, doorknob, headlight, taillight, aluminum wheel, and gasoline tank of motorcycle, etc.
optical use, such as camera parts to be mounted to a variety of camera units, such as, a lens, lens barrel inner wall, inner/outer cover of a lens unit and spacer of lens, etc.
glasses, goggles and other similar products
hobby products made of resin mold parts and parts for building them (for example, a model for building (plastic model, etc.) and parts of model for building in the model kit, etc.)

A thickness of a membrane formed from a paint according to one mode may be adjusted properly in accordance with use purposes of an object to be coated, etc. and is not particularly limited. To raise an example of a preferable thickness of a membrane, it is preferably 2 μm or more, more preferably 5 μm or more and preferably 40 μm or less and more preferably 25 μm or less. Note that a thickness of a membrane to be formed from a paint according to one mode indicates a height including parts protruding from a surface of an object to be coated due to (B) in the membrane. A thickness of a membrane may be measured by a method based on JIS K7130.

### <Characteristics of Membrane>

Characteristics of a membrane formed from the paint as above are as below.

(Glossiness, Reflectance, L value, Optical Density, Adhesiveness and Membrane Strength (Abrasion Resistance)) A membrane formed from the paint above preferably has glossiness of less than 1%, reflectance of less than 1.5% and an L value of less than 15 on its membrane surface. In the case where a light-shielding characteristic when transmitting light is required to a membrane to be formed from the paint, it is furthermore preferable that an optical density on the membrane surface is 2 or more in addition to the above characteristics (glossiness of less than 1%, reflectance less than 1.5% and L value less than 15 on the membrane surface).

Here, when configured that a membrane formed from the paint above is exposed as an outermost surface, glossiness, reflectance, an L value and, if needed, an optical density on a real surface of the membrane are preferably in the ranges as above. While when another membrane is coated on a membrane formed from the paint, glossiness, reflectance, an L value and, if needed, an optical density on a surface of this another membrane, that is, an outermost surface of the membrane formed on an object to be coated preferably has glossiness, reflectance, an L value and, if needed, an optical density in the ranges above. Hereinafter, these surfaces will be referred to as “an outermost surface of a membrane”.

An outermost surface of a membrane formed from the paint above preferably has glossiness of less than 1%, reflectance of less than 1.5% and an L value of less than 15. In the case where a light-shielding characteristic when transmitting a light is required, it is furthermore preferable that an optical density on the outermost surface of the membrane is 2 or more in addition to the above characteristics (glossiness of less than 1%, reflectance less than 1.5% and an L value less than 15 on the outermost surface of the membrane). When glossiness, reflectance, an L value and, as needed, an optical density on an outermost surface of a membrane are in the ranges as above, it is possible to attain low glossiness, low reflectance, a high blackness degree and, as needed, a high light-shielding characteristic on the outermost surface of the membrane.

The uppermost value of glossiness is more preferably less than 0.7% and furthermore preferably less than 0.5%. When glossiness is adjusted to be in the range above, a flare ghost phenomenon due to irregular reflection of lights can be prevented effectively. A lower limit value of glossiness is not particularly limited, and the lower, the better.

An uppermost value of reflectance is more preferably less than 1.25% and furthermore preferably less than 1.0%. A lower limit value of reflectance is not particularly limited. The lower the reflectance is, the better. When reflectance is adjusted to be in the range above, a flare ghost phenomenon due to irregular reflection of lights can be prevented furthermore effectively.

An uppermost value of an L value (a blackness degree) is more preferably less than 12 and furthermore preferably less than 10. A lower limit value of an L value is not particularly limited, however, in terms of demands for real blackness on appearance, the lower, the better. When an L value is adjusted to be in the range above, the blackness is enhanced and blackness outstands so as to attain excellent designability, therefore, it can be preferably used as a camera unit, etc. of smartphones and other cellular phones.

The L value above is a lightness L*value on an outermost surface of a membrane, which is in CIE 1976 L*a*b* (CIELAB) color space system based on a SCE method. The SCE method is a specularly reflected light removal method, which means a method of measuring color by removing specularly reflected lights. Definition of the SCE method is defined in JIS Z8722 (2009). Since specularly reflected lights are removed in the SCE method, the color is close to the color actually viewed by human.

CIE is abbreviation of Commission Internationale de l'Eclairage, which means international committee on illumination. The CIELAB color space was adopted in 1976 in order to measure color difference between perception and devices and is a uniform color space defined in JIS Z 8781 (2013). Three coordinates in CIELAB are indicated by L*value, a*value and b*value. The L*value indicates lightness and expressed from 0 to 100. When L*value is 0, it indicates black, while it indicates white diffusion color when L*value is 100. The a*value indicates colors between red and green. When a*value is in minus, it indicates colors close to green, while when in plus, it indicates colors close to red. The b*value indicates colors between yellow and blue. When b*value is in minus, it indicates colors close to blue, while it indicates colors close to yellow when in plus.

In the case, where a light-shielding characteristic when transmitting light is required to a membrane formed from a composition, a lower limit value of an optical density is more preferably 2.5 or more and furthermore preferably 3.2 or more. When optical density is adjusted to be in the range above, a light-shielding characteristic can be enhanced furthermore. An upper limit value of an optical density is not particularly limited, and the higher, the better.

The glossiness, reflectance, an L value and optical density explained above can be measured by methods explained later on.

In addition to the characteristics (glossiness, reflectance, an L value and, when necessary, optical density) above, a membrane formed from the paint above preferably has good adhesiveness to a surface of an object to be coated. Adhesiveness of a membrane formed from the paint to a surface of an object to be coated preferably satisfies that 90% or more of the coating remain as explained in adhesiveness evaluation in later-explained examples. Moreover, a membrane formed form the paint above preferably has high membrane strength. Membrane strength of a membrane formed from the paint above is, as indicated in later-explained evaluation on anti-friction characteristic in examples, that a number of damaged/scratched lines based on JIS K5600 May 10 ISO 7784-3 is preferably 10 or less, more preferably 2 or less and furthermore preferably 0.

### EXAMPLES

Below, the present invention will be explained specifically based on Experimental examples (including Working Examples and Comparative Examples), however, the present invention is not limited to the Experimental examples. Below, “part” indicates “part by mass” and “%” indicates “% by mass”.

### [Components of Composition]

As A (a resin component), substances below were prepared.
A1: polyvinyl acetal resin (S-LEC by SEKISUI CHEMICAL Co., Ltd.)
   A1a: BL-S
   (an acetalized degree: approximately 72 mol %, an amount of hydroxy-group: approximately 23 mol %, an amount of acetyl-group: 4-6 mol %, calculated molecular weight: approximately 23000 and Tg: 66° C.)
   A1b: BM-S(Z)
   (an acetalized degree: approximately 72 mol %, an amount of hydroxy-group: approximately 23 mol %, an amount of acetyl-group: 4-6 mol %, calculated molecular weight: approximately 55000 and Tg: 67° C.).
   A1c: BH-S
   (an acetalized degree: approximately 72 mol %, an amount of hydroxy-group: approximately 23 mol %, an amount of acetyl-group: 4-6 mol %, calculated molecular weight: approximately 66000 and Tg: 67° C.)
   A1d: BX-5 (Z)
   (an acetalized degree: approximately 72 mol %, an amount of hydroxy-group: approximately 27 mol %, an amount of acetyl-group: 3 mol % or less, calculated molecular weight: approximately 130000 and Tg: 92° C.)
   A1e: KS-5Z
   (an acetalized degree: approximately 74 mol %, an amount of hydroxy-group: approximately 25 mol %, an amount of acetyl-group: 3 mol % or less, calculated molecular weight: approximately 130000, Tg: 113° C.)
A2: thermosetting acrylic resin (ACRYDIC A801 by DIC Corporation) (resin Tg: 67° C., a resin solid content: 34%, molecular weight 15000, acid value 1 mgKOH/g and hydroxyl group 5 mgKOH/g)

As B (a black material), the followings were prepared.
B1a: black acrylic beads (a particle diameter 3 to 5 μm)
(Art Pearl GR-004BK by Negami Chemical Industrial Co., Ltd., CB content 35 to 39%)
B2a: black acrylic beads (particle diameter 14 to 16 μm)
(Art Pearl GR-400BK by Negami Chemical Industrial Co., Ltd., CB content 6 to 10%)
B2b: CB (particle diameter 150 nm)
(MHI Black_#273 by MIKUNI COLOR Ltd., CB content 9.5%)
B2c: composite silica (particle diameter 3 μm)
(BECSIA ID, by Fuji Silysia Chemical Ltd.)
B2d: transparent acrylic beads (particle diameter 3 μm) (ENEOS Uni-Powder MNB-0320C by ENEOS Corporation)
B2e: transparent acrylic beads (particle diameter 2 μm)
(ENEOS Uni-Powder MNB-0220C by ENEOS Corporation)

The “Art Pearl GR-004BK” used as B1a and “Art Pearl GR-400BK” used as B2a are spherical acrylic resin particles containing CB therein and is one of composites of CB and an acrylic resin. The “MHI Black #273” used as B2b (CB) is a CB dispersion liquid, wherein 9.5% out of a total solid content of 18% in the dispersion liquid is CB and remaining 8.5% is other compounds. The “BECSIA ID” used as B2c (composite silica) is a composite particle of CB and silica, wherein CB/silica=approximately 25/75 (a mass ratio).

As D (optional component), a substance below was prepared.
D1: isocyanate compound
(TAKENATE D110N by Mitsui Chemicals, Inc., solid content 75%) As an object to be coated, a chassis of a smartphone (an outer case made of plastic) was prepared.

### Experimental Examples 1 to 20 and 5a to 16a

### 1. Preparation of Paint

In a mixed solvent of methyl ethyl ketone and butyl acetate in predetermined amounts as shown in Tables 1 to 3, respective components for each Experimental example were put in, so that a solid content ratio of a total solid content (% by mass) and a solid content of each of the respective components become each of the values described in Tables 1 to 3, and mixed by agitating so as to prepare a paint.

### 2-1. Formation of Membrane 1

Each paint obtained for each Experimental example was sprayed against an object to be coated by a spray coating method in the same way as in (3-3-1) Applicability 1 below so as to form a coating film, then, the coating film was heated at 120° C. for 3 minutes to dry, so that a membrane 1 having an average film thickness of 10 μm was formed by a spray coating method on a surface of an object to be coated.

### 2-2. Formation of Membrane 2

By using a brush painting method as the same way as in (3-3-2) Applicability 2 below, a coating film was formed on an object to be coated, then the coating film was heated at 120° C. for 3 minutes to dry, so that a membrane 2 having an average film thickness of 10 μm was formed by a brush painting method on a surface of an object to be coated.

### 3. Evaluation

On each paint obtained in each of the Experimental examples, a variety of characteristics (viscosity, injection performance, applicability and a liquid dripping characteristic) were evaluated (paint evaluation) in the methods explained below. Also, on a membrane formed from a paint obtained for each of the Experimental examples, a variety of characteristics (properties) were evaluated (membrane evaluation) in the methods explained below. The results are shown in Tables 1 to 3.

### [Paint Evaluation]

### (3-1-1) Viscosity 1

Viscosity 1 of a paint was measured by using a B-type viscometer (VISCOMETER BM2 by TOKISANGYO) under a condition of 60 rpm with a No. 1 rotor after one minute at 25° C. Evaluation reference is as below.
◯: Viscosity was 1 mPa·s or more and 50 mPa·s or less. (preferable viscosity)
X: Viscosity exceeded 50 mPa·s. (excessively high viscosity)

### (3-1-2) Viscosity 2

Viscosity 2 of a paint was measured by using a B-type viscometer (VISCOMETER BM2 by TOKISANGYO) under a condition of 60 rpm with a No. 2 rotor after one minute at 25° C. Evaluation reference is as below.
◯: Viscosity was 100 mPa·s or more and 2000 mPa·s or less. (preferable viscosity)
X: Viscosity exceeded 2000 mPa·s. (excessively high viscosity)

### (3-2) Injection Performance

Injection performance was evaluated by observing a state of injecting the paint to an air spray.

An air spray, wherein an air brush (Spray-Work HG Single Airbrush, by TAMIYA, Inc.) was attached to an air can (Spray-Work Air Can 420D, by TAMIYA, Inc.), was used and a state that each paint enters from a cup of an air brush to a nozzle was observed visually to evaluate injection performance. Evaluation reference is as below.
◯: A paint entered smoothly to the nozzle with no clogging.
Δ: There was no clogging but speed of the paint entering to the nozzle was slow.
X: A paint clogged and did not enter the nozzle.

### (3-3-1) Applicability 1

Applicability 1 of a paint was evaluated by observing coating unevenness after applying by a spray coating method. Each paint was poured into an air spray used in (3-2) above, atomizing from a tip of the air brush toward an outer surface of an object to be coated from a 10 cm distance for 10 seconds, and application unevenness on a coating film (before drying) was evaluated visually.

### (3-3-2) Applicability 2

Applicability 2 of a paint was evaluated by observing application unevenness after applying by a brush painting method. Each paint was put on a tip of a brush to draw a line of 10 cm on a SUS plate, then application unevenness of a formed coating film (before drying) was evaluated visually.

Evaluation reference of applicability 1 and applicability 2 is as below.
⊚: Coating unevenness (unevenness in thickness) was not observed.
◯: Coating unevenness was observed partially.
X: Coating unevenness was observed in many areas.

### (3-4) Liquid Dripping Characteristic

A liquid dripping characteristic of a paint was evaluated by observing liquid dripping from an object to be coated after applying by a spray coating method.

In the same way as in (3-3-1) above, each paint was poured into the air spray used in (3-2) above, and after atomizing from a tip of the air brush toward an outer surface of an object to be coated for 10 seconds from a 10 cm distance, a liquid dripping characteristic of adhered droplets from the object to be coated was evaluated. Evaluation reference is as below.
◯: Even when a coated object was placed vertically, there was no dripping.
Δ: When a coated object was placed vertically, the liquid dripped gradually.
X: When a coated object was placed vertically, the liquid started to drip immediately.

### [Membrane Evaluation]

### (3-5) Characteristics

### —Glossiness—

Glossiness against a measurement light having an incident angle of 60°(specular glossiness at) 60° on a surface of a membrane formed on each object to be coated was measured on 9 spots by using a glossmeter (VG 7000, by NIPPON DENSHOKU Industries Co., Ltd.) by the method based on JIS Z8741, and an average value thereof was adopted as a glossiness degree. Evaluation reference is as below.
⊚: A glossiness degree was less than 0.5%. (extremely excellent low glossiness)
◯: A glossiness degree was 0.5% or more but less than 0.7%. (excellent low glossiness)
Δ: A glossiness degree was 0.7% or more but less than 1%. (preferably low glossiness)
X: A glossiness degree was 1% or more. (not low enough glossiness)

### —Reflectance—

Reflectance against a light having a wavelength of 550 nm (550 nm reflectance) on each surface of a membrane formed on each object to be coated was measured at 9 spots by using a special colorimeter (CM-5, by Konica Minolta Inc.) by the method based on JIS Z8722, and an average value thereof was adopted as reflectance. Evaluation reference is as below.
⊚: Reflectance was less than 1%. (extremely excellent low reflectance)
◯: Reflectance was 1% or more but less than 1.25%. (excellent low reflectance)
Δ: Reflectance was 1.25% or more but less than 1.5%. (preferable low reflectance)
X: Reflectance was 1.5% or more. (not low enough reflectance)

### —BlacknessDegree—

A degree of blackness on a surface of a membrane formed on each object to be coated was evaluated by measuring lightness L*value in CIE 1976 L*a*b* (CIELAB) color space system on the membrane surface by the SCE method. The lightness L*value was measured by using a spectral colorimeter (CM-5, by Konica Minolta Inc.) by the method based on JIS Z8781-4:2013. Evaluation reference is as below.

When measuring, a CIE standard light source D65 was used as a light source and an L* value in the CIELAB color space system was obtained at a viewing angle of 10° by the SCE method. The CIE standard light source D65 is defined in JIS Z8720 (2000) “Standard Illuminants and Sources for Colorimetry”, and ISO 10526 (2007) also shows the same definition. The CIE standard light source D65 is used in the case of displaying colors of an object illuminated by daylight. A viewing angle of 10° is defined in JIS Z8723 (2009) “Methods of Visual Comparison for Surface Colours”, and ISO/DIS 3668 also shows the same definition.
⊚: An L value was less than 10. (an extremely excellent blackness degree)
◯: An L value was 10 or more but less than 12. (an excellent blackness degree)
Δ: An L value was 12 or more but less than 15. (a preferable blackness degree)
X: An L value was 15 or more. (an insufficient blackness degree)

### —Light-Shielding Characteristic—

A light-shielding characteristic of a membrane formed on each object to be coated was evaluated by calculating an optical density of each membrane. An optical density of each of the membranes formed on respective objects to be coated was obtained by using an optical density meter (X-rite 361T (ortho filter), by Nihon Heihan Kizai Kabushiki Kaisha), irradiating a vertical transmission light flux to the membrane side of an object to be coated, and calculating by expressing a ratio with respect to a state without a membrane in log (logarithms). An optical density of 6.0 or more is an upper limit value of detection in the measurement. Evaluation reference is as below. Note that this evaluation is on an assumption that an object to be coated itself has transmissivity and that a membrane formed thereon is required to have a light-shielding characteristic. When the membrane is not required to have any light-shielding characteristic, an evaluation here does not affect comprehensive evaluation thereof.
⊚: An optical density was 3.2 or more. (an extremely excellent light-shielding characteristic)
◯: An optical density was 2.5 or more but less than 3.2. (an excellent light-shielding characteristic)
Δ: An optical density was 2 or more but less than 2.5. (a preferable light-shielding characteristic)
X: An optical density was less than 2. (an insufficient light-shielding characteristic)

### —Adhesiveness—

Adhesiveness of a membrane formed on each of the respective objects to be coated to each of the surfaces of the objects to be coated was evaluated by cutting a membrane in a grid pattern with a market-available cutter, putting thereon a cellophane tape (Cellulose tape produced by NICHIBAN Co., Ltd.), then taking off the tape, and visually observing a remaining state of the membrane. Evaluation reference is as below.
⊚: A membrane remained 100%. (extremely excellent adhesiveness)
◯: A membrane remained 95% or more and less than 100%. (excellent adhesiveness)
Δ: A membrane remained 90% or more and less than 95%. (preferable adhesiveness)
X: A membrane remained less than 90%. (insufficient adhesiveness)

### —Abrasion Resistance 1—

An abrasion resistance 1 of a membrane formed on each object to be coated was evaluated by measuring scratches on a membrane surface by using an abrasion tester (Suga Abrasion Tester NUS-ISO3) based on JIS K5600 May 10 ISO 7784-3. The measurement condition was that a test piece No. 1 (one mode of an object to be coated formed with a membrane (the same applies to the following)) cut into a size according to a jig was reciprocated back and forth for 10 times against a test piece No. 2, having a size according to a rotary ring, wound around the rotation ring positioned under the test piece No. 1 so as to rub and wear with a load of 100 g (the weight may set to be 100 g to 3 kg). Evaluation was made by checking whether there arose any scratch on a membrane surface of the test piece No. 1 or not. The rotation ring rotates 0.9° every time the test piece No. 1 moves back and forth for one time so that a new abrading surface of the test piece No. 2 always wears the test piece No. 1. Evaluation reference is as below.
⊚: 0 scratch (an extremely excellent abrasion resistance)
◯: 1 to 2 scratches (an excellent abrasion resistance)
Δ: 3 to 10 scratches (a preferable abrasion resistance)
X: 11 or more scratches (an insufficient abrasion resistance)

### —Abrasion Resistance 2—

An abrasion resistance 2 of a membrane formed on each of the objects to be coated was evaluated by using melamine sponge (Gekiochikun and melamine foam by LEC, Inc.) and observing an existence of scratches. A membrane surface formed on each of objects to be coated was rubbed with a load of 200 g on an area of 7 cm² back and forth for 30 times, then an existence of a scratch was checked visually to evaluate. Evaluation reference is as below.
⊚: no change (an extremely excellent abrasion resistance)
◯: 1 to 2 light scratches (an excellent abrasion resistance)
Δ: 3 to 10 light scratches (a preferable abrasion resistance)
X: 11 or more light scratches (an insufficient abrasion resistance)
XX: Sharp scratches arose over the entire rubbed surface (a defective abrasion resistance)

### —Comprehensive Evaluation—

Glossiness, reflectance, a blackness degree, adhesiveness and abrasion resistances 1 and 2 explained above were evaluated comprehensively. Evaluation reference is as below. Note that a light-shielding characteristic was omitted from the comprehensive evaluation because, as explained above, it is required in some cases but not required in other cases.
⊚: Evaluations on glossiness, reflectance, a blackness degree, adhesiveness and abrasion resistances 1 and 2 were all ⊚.
◯: At least one of the evaluations on glossiness, reflectance, a blackness degree, adhesiveness and abrasion resistances 1 and 2 was ◯, but there was no X.
X: At least one of the evaluations on glossiness, reflectance, a blackness degree, adhesiveness and abrasion resistances 1 and 2 was X.

TABLE 1

| | | | | | | EXPERIMENTAL EXAMPLES | |
|---|---|---|---|---|---|---|---|
| | | COMPONENTS | | | | 1 | 2 |
| PAINT | COMPOSITION | A | A1 | A1a | BL-S | 0 | 0 |
| COMPOSITION | | | | A1b | BM-S(Z) | 0 | 0 |
| | | | | A1c | BH-S | 0 | 0 |
| | | | | A1d | BX-5(Z) | 0 | 0 |
| | | | | A1e | KS-5Z | 0 | 0 |
| | | | OTHER | A2 | A801 | 60 | 60 |
| | | | THAN A1 | | | | |

| D | D1 | | ISOCYANATE COMPOUND | 40 | 40 |
|---|---|---|---|---|---|
| B | B1 | B1a | BLACK ACRYLIC | 600 | 0 |
| | | | BEADS (3-5 μm) | | |
| | OTHER | B2a | BLACK ACRYLIC | 0 | 0 |
| | | | BEADS (14-16 μm) | | |
| | THAN | B2b | CARBON BLACK | 0 | 15 |
| | | | (150 nm) | | |
| | B1 | B2c | COMPOSITE SILICA | 0 | 40 |
| | | | (3 μm) | | |
| | | B2d | TRANSPARENT ACRYLIC | 0 | 0 |
| | | | BEADS (3 μm) | | |
| | | B2e | TRANSPARENT ACRYLIC | 0 | 0 |
| | | | BEADS (2 μm) | | |

| | ※A:B = 1:• (MASS RATIO) | | 10.0 | 0.9 |
|---|---|---|---|---|
| | ※(A + B + D):B = 100:• | | 85.7 | 35.5 |
| | (MASS RATIO) | | | |
| C | C1 | METHYL ETHYL | 1400 | 310 |
| | | KETONE | | |
| | C2 | BUTYL ACETATE | 1400 | 310 |

| | TOTAL SOLID CONTENT (%) | | | 20 | 20 |
|---|---|---|---|---|---|
| CHARACTERISTIC | | PAINT | VISCOSITY 1 | ◯ | ◯ |
| EVALUATION | | | INJECTION PERFORMANCE | ◯ | ◯ |
| | | | APPLICABILITY 1 | ◯ | ◯ |
| | | | (SPRAY COATING) | | |
| | | | LIQUID DRIPPING | ◯ | ◯ |
| | | | CHARACTERISTIC | | |
| | | MEMBRANE | GLOSSINESS (SPECULAR | ⊚ | ⊚ |
| | | CHARACTERISTICS | GLOSSINESS AT 60°) | | |
| | | | REFLECTANCE (550 | X | X |
| | | | nm REFLECTANCE) | | |
| | | | L VALUE (L* VALUE IN | Δ | X |
| | | | CIELAB COLOR SPACE SYSTEM) | | |
| | | | LIGHT-SHIELDING | ⊚ | ⊚ |
| | | | CHARACTERISTIC | | |
| | | | ADHESIVENESS | X | ⊚ |
| | | | ABRASION RESISTANCE 1 | X | X |
| | | | ABRASION RESISTANCE 2 | X | X |
| | | | ※COMPREHENSIVE | X | X |
| | | | EVALUATION | | |

| | | | | | | EXPERIMENTAL EXAMPLES | | |
|---|---|---|---|---|---|---|---|---|
| | | COMPONENTS | | | | 3 | 4 | 5 |
| PAINT | COMPOSITION | A | A1 | A1a | BL-S | 0 | 0 | 0 |
| COMPOSITION | | | | A1b | BM-S(Z) | 0 | 0 | 60 |
| | | | | A1c | BH-S | 0 | 0 | 0 |
| | | | | A1d | BX-5(Z) | 0 | 0 | 0 |
| | | | | A1e | KS-5Z | 0 | 0 | 0 |
| | | | OTHER | A2 | A801 | 60 | 60 | 0 |
| | | | THAN A1 | | | | | |

| D | D1 | | ISOCYANATE COMPOUND | 40 | 40 | 40 |
|---|---|---|---|---|---|---|
| B | B1 | B1a | BLACK ACRYLIC | 0 | 0 | 600 |
| | | | BEADS (3-5 μm) | | | |
| | OTHER | B2a | BLACK ACRYLIC | 0 | 0 | 0 |
| | | | BEADS (14-16 μm) | | | |
| | THAN | B2b | CARBON BLACK | 25 | 84 | 0 |
| | | | (150 nm) | | | |
| | B1 | B2c | COMPOSITE SILICA | 0 | 0 | 0 |
| | | | (3 μm) | | | |
| | | B2d | TRANSPARENT ACRYLIC | 97.5 | 0 | 0 |
| | | | BEADS (3 μm) | | | |
| | | B2e | TRANSPARENT ACRYLIC | 0 | 96 | 0 |
| | | | BEADS (2 μm) | | | |

| | ※A:B = 1:• (MASS RATIO) | | 2.0 | 3.0 | 10.0 |
|---|---|---|---|---|---|
| | ※(A + B + D):B = 100:• | | 55.1 | 64.3 | 85.7 |
| | (MASS RATIO) | | | | |
| C | C1 | METHYL ETHYL | 450 | 550 | 1400 |
| | | KETONE | | | |
| | C2 | BUTYL ACETATE | 450 | 550 | 1400 |

| | TOTAL SOLID CONTENT (%) | | | 20 | 20 | 20 |
|---|---|---|---|---|---|---|
| CHARACTERISTIC | | PAINT | VISCOSITY 1 | ◯ | ◯ | ◯ |
| EVALUATION | | | INJECTION PERFORMANCE | ◯ | ◯ | ◯ |
| | | | APPLICABILITY 1 | ◯ | ◯ | ◯ |
| | | | (SPRAY COATING) | | | |
| | | | LIQUID DRIPPING | ◯ | ◯ | ◯ |
| | | | CHARACTERISTIC | | | |
| | | MEMBRANE | GLOSSINESS (SPECULAR | ◯ | X | ⊚ |
| | | CHARACTERISTICS | GLOSSINESS AT 60°) | | | |
| | | | REFLECTANCE (550 | X | X | ◯ |
| | | | nm REFLECTANCE) | | | |
| | | | L VALUE (L* VALUE IN | X | X | ◯ |
| | | | CIELAB COLOR SPACE SYSTEM) | | | |
| | | | LIGHT-SHIELDING | ◯ | ⊚ | ⊚ |
| | | | CHARACTERISTIC | | | |
| | | | ADHESIVENESS | ⊚ | ⊚ | ⊚ |
| | | | ABRASION RESISTANCE 1 | ◯ | ◯ | ◯ |
| | | | ABRASION RESISTANCE 2 | ◯ | ◯ | ◯ |
| | | | ※COMPREHENSIVE | X | X | ◯ |
| | | | EVALUATION | | | |

| | | | | | | EXPERIMENTAL EXAMPLES | | |
|---|---|---|---|---|---|---|---|---|
| | | COMPONENTS | | | | 6 | 7 | 8 |
| PAINT | COMPOSITION | A | A1 | A1a | BL-S | 0 | 0 | 0 |
| COMPOSITION | | | | A1b | BM-S(Z) | 60 | 60 | 60 |
| | | | | A1c | BH-S | 0 | 0 | 0 |
| | | | | A1d | BX-5(Z) | 0 | 0 | 0 |
| | | | | A1e | KS-5Z | 0 | 0 | 0 |
| | | | OTHER | A2 | A801 | 0 | 0 | 0 |
| | | | THAN A1 | | | | | |
| | | D | D1 | | ISOCYANATE COMPOUND | 40 | 40 | 40 |
| | | B | B1 | B1a | BLACK ACRYLIC | 0 | 0 | 0 |
| | | | | | BEADS (3-5 μm) | | | |
| | | | OTHER | B2a | BLACK ACRYLIC | 600 | 0 | 0 |
| | | | | | BEADS (14-16 μm) | | | |
| | | | THAN | B2b | CARBON BLACK | 0 | 600 | 0 |
| | | | | | (150 nm) | | | |
| | | | B1 | B2c | COMPOSITE SILICA | 0 | 0 | 600 |
| | | | | | (3 μm) | | | |
| | | | | B2d | TRANSPARENT ACRYLIC | 0 | 0 | 0 |
| | | | | | BEADS (3 μm) | | | |
| | | | | B2e | TRANSPARENT ACRYLIC | 0 | 0 | 0 |
| | | | | | BEADS (2 μm) | | | |
| | | | ※A:B = 1:• (MASS RATIO) | | | 10.0 | 10.0 | 10.0 |
| | | | ※(A + B + D):B = 100:• | | | 85.7 | 85.7 | 85.7 |
| | | | (MASS RATIO) | | | | | |
| | | C | C1 | | METHYL ETHYL | 1400 | 1400 | 1400 |
| | | | | | KETONE | | | |
| | | | C2 | | BUTYL ACETATE | 1400 | 1400 | 1400 |
| | TOTAL SOLID CONTENT (%) | | | | | 20 | 20 | 20 |
| CHARACTERISTIC | | PAINT | VISCOSITY 1 | | | ◯ | ◯ | ◯ |
| EVALUATION | | | INJECTION PERFORMANCE | | | ◯ | ◯ | ◯ |
| | | | APPLICABILITY 1 | | | ◯ | ◯ | ◯ |
| | | | (SPRAY COATING) | | | | | |
| | | | LIQUID DRIPPING | | | ◯ | ◯ | ◯ |
| | | | CHARACTERISTIC | | | | | |
| | | MEMBRANE | GLOSSINESS (SPECULAR | | | ⊚ | X | ⊚ |
| | | CHARACTERISTICS | GLOSSINESS AT 60°) | | | | | |
| | | | REFLECTANCE (550 | | | X | ⊚ | X |
| | | | nm REFLECTANCE) | | | | | |
| | | | L VALUE (L* VALUE IN | | | X | ⊚ | Δ |
| | | | CIELAB COLOR SPACE SYSTEM) | | | | | |
| | | | LIGHT-SHIELDING | | | X | ⊚ | ⊚ |
| | | | CHARACTERISTIC | | | | | |
| | | | ADHESIVENESS | | | ⊚ | X | X |
| | | | ABRASION RESISTANCE 1 | | | ◯ | X | X |
| | | | ABRASION RESISTANCE 2 | | | ◯ | X | X |
| | | | ※COMPREHENSIVE | | | X | X | X |
| | | | EVALUATION | | | | | |
| | | | | | | EXPERIMENTAL EXAMPLES | | |
| | | COMPONENTS | | | | 9 | 10 | 11 |
| PAINT | COMPOSITION | A | A1 | A1a | BL-S | 0 | 0 | 0 |
| COMPOSITION | | | | A1b | BM-S(Z) | 60 | 60 | 60 |
| | | | | A1c | BH-S | 0 | 0 | 0 |
| | | | | A1d | BX-5(Z) | 0 | 0 | 0 |
| | | | | A1e | KS-5Z | 0 | 0 | 0 |
| | | | OTHER | A2 | A801 | 0 | 0 | 0 |
| | | | THAN A1 | | | | | |
| | | D | D1 | | ISOCYANATE COMPOUND | 40 | 40 | 40 |
| | | B | B1 | B1a | BLACK ACRYLIC | 0 | 0 | 410 |
| | | | | | BEADS (3-5 μm) | | | |
| | | | OTHER | B2a | BLACK ACRYLIC | 0 | 0 | 0 |
| | | | | | BEADS (14-16 μm) | | | |
| | | | THAN | B2b | CARBON BLACK | 0 | 0 | 0 |
| | | | | | (150 nm) | | | |
| | | | B1 | B2c | COMPOSITE SILICA | 0 | 0 | 0 |
| | | | | | (3 μm) | | | |
| | | | | B2d | TRANSPARENT ACRYLIC | 600 | 0 | 0 |
| | | | | | BEADS (3 μm) | | | |
| | | | | B2e | TRANSPARENT ACRYLIC | 0 | 600 | 0 |
| | | | | | BEADS (2 μm) | | | |
| | | | ※A:B = 1:• (MASS RATIO) | | | 10.0 | 10.0 | 6.8 |
| | | | ※(A + B + D):B = 100:• | | | 85.7 | 85.7 | 80.4 |
| | | | (MASS RATIO) | | | | | |
| | | C | C1 | | METHYL ETHYL | 1400 | 1400 | 1050 |
| | | | | | KETONE | | | |
| | | | C2 | | BUTYL ACETATE | 1400 | 1400 | 1050 |
| | TOTAL SOLID CONTENT (%) | | | | | 20 | 20 | 20 |
| CHARACTERISTIC | | PAINT | VISCOSITY 1 | | | ◯ | ◯ | ◯ |
| EVALUATION | | | INJECTION PERFORMANCE | | | ◯ | ◯ | ◯ |
| | | | APPLICABILITY 1 | | | ◯ | ◯ | ◯ |
| | | | (SPRAY COATING) | | | | | |
| | | | LIQUID DRIPPING | | | ◯ | ◯ | ◯ |
| | | | CHARACTERISTIC | | | | | |
| | | MEMBRANE | GLOSSINESS (SPECULAR | | | ⊚ | ⊚ | ⊚ |
| | | CHARACTERISTICS | GLOSSINESS AT 60°) | | | | | |
| | | | REFLECTANCE (550 | | | X | X | X |
| | | | nm REFLECTANCE) | | | | | |
| | | | L VALUE (L* VALUE IN | | | X | X | Δ |
| | | | CIELAB COLOR SPACE SYSTEM) | | | | | |
| | | | LIGHT-SHIELDING | | | X | X | ◯ |
| | | | CHARACTERISTIC | | | | | |
| | | | ADHESIVENESS | | | ◯ | ◯ | ◯ |
| | | | ABRASION RESISTANCE 1 | | | ◯ | ◯ | ◯ |
| | | | ABRASION RESISTANCE 2 | | | ◯ | ◯ | ◯ |
| | | | ※COMPREHENSIVE | | | X | X | X |
| | | | EVALUATION | | | | | |
| | | | | | | EXPERIMENTAL EXAMPLES | | |
| | | COMPONENTS | | | | 12 | 13 | 5 |
| PAINT | COMPOSITION | A | A1 | A1a | BL-S | 0 | 0 | 0 |
| COMPOSITION | | | | A1b | BM-S(Z) | 60 | 60 | 60 |
| | | | | A1c | BH-S | 0 | 0 | 0 |
| | | | | A1d | BX-5(Z) | 0 | 0 | 0 |
| | | | | A1e | KS-5Z | 0 | 0 | 0 |
| | | | OTHER | A2 | A801 | 0 | 0 | 0 |
| | | | THAN A1 | | | | | |
| | | D | D1 | | ISOCYANATE COMPOUND | 40 | 40 | 40 |
| | | B | B1 | B1a | BLACK ACRYLIC | 490 | 550 | 600 |
| | | | | | BEADS (3-5 μm) | | | |
| | | | OTHER | B2a | BLACK ACRYLIC | 0 | 0 | 0 |
| | | | | | BEADS (14-16 μm) | | | |
| | | | THAN | B2b | CARBON BLACK | 0 | 0 | 0 |
| | | | | | (150 nm) | | | |
| | | | B1 | B2c | COMPOSITE SILICA | 0 | 0 | 0 |
| | | | | | (3 μm) | | | |
| | | | | B2d | TRANSPARENT ACRYLIC | 0 | 0 | 0 |
| | | | | | BEADS (3 μm) | | | |
| | | | | B2e | TRANSPARENT ACRYLIC | 0 | 0 | 0 |
| | | | | | BEADS (2 μm) | | | |
| | | | ※A:B = 1:• (MASS RATIO) | | | 8.2 | 9.2 | 10.0 |
| | | | ※(A + B + D):B = 100:• | | | 83.1 | 84.6 | 85.7 |
| | | | (MASS RATIO) | | | | | |
| | | C | C1 | | METHYL ETHYL | 1200 | 1300 | 1400 |
| | | | | | KETONE | | | |
| | | | C2 | | BUTYL ACETATE | 1200 | 1300 | 1400 |
| | TOTAL SOLID CONTENT (%) | | | | | 20 | 20 | 20 |
| CHARACTERISTIC | | PAINT | VISCOSITY 1 | | | ◯ | ◯ | ◯ |
| EVALUATION | | | INJECTION PERFORMANCE | | | ◯ | ◯ | ◯ |
| | | | APPLICABILITY 1 | | | ◯ | ◯ | ◯ |
| | | | (SPRAY COATING) | | | | | |
| | | | LIQUID DRIPPING | | | ◯ | ◯ | ◯ |
| | | | CHARACTERISTIC | | | | | |
| | | MEMBRANE | GLOSSINESS (SPECULAR | | | ⊚ | ⊚ | ⊚ |
| | | CHARACTERISTICS | GLOSSINESS AT 60°) | | | | | |
| | | | REFLECTANCE (550 | | | Δ | ◯ | ◯ |
| | | | nm REFLECTANCE) | | | | | |
| | | | L VALUE (L* VALUE IN | | | ◯ | ◯ | ◯ |
| | | | CIELAB COLOR SPACE SYSTEM) | | | | | |
| | | | LIGHT-SHIELDING | | | ⊚ | ⊚ | ⊚ |
| | | | CHARACTERISTIC | | | | | |
| | | | ADHESIVENESS | | | ⊚ | ⊚ | ⊚ |
| | | | ABRASION RESISTANCE 1 | | | ◯ | ◯ | ◯ |
| | | | ABRASION RESISTANCE 2 | | | ◯ | ◯ | ◯ |
| | | | ※COMPREHENSIVE | | | ◯ | ◯ | ◯ |
| | | | EVALUATION | | | | | |
| | | | | | | EXPERIMENTAL EXAMPLES | | |
| | | COMPONENTS | | | | 14 | 15 | 16 |
| PAINT | COMPOSITION | A | A1 | A1a | BL-S | 0 | 0 | 0 |
| COMPOSITION | | | | A1b | BM-S(Z) | 60 | 60 | 60 |
| | | | | A1c | BH-S | 0 | 0 | 0 |
| | | | | A1d | BX-5(Z) | 0 | 0 | 0 |
| | | | | A1e | KS-5Z | 0 | 0 | 0 |
| | | | OTHER | A2 | A801 | 0 | 0 | 0 |
| | | | THAN A1 | | | | | |

| D | D1 | | ISOCYANATE COMPOUND | 40 | 40 | 40 |
|---|---|---|---|---|---|---|
| B | B1 | B1a | BLACK ACRYLIC | 700 | 830 | 850 |
| | | | BEADS (3-5 μm) | | | |
| | OTHER | B2a | BLACK ACRYLIC | 0 | 0 | 0 |
| | | | BEADS (14-16 μm) | | | |
| | THAN | B2b | CARBON BLACK | 0 | 0 | 0 |
| | | | (150 nm) | | | |
| | B1 | B2c | COMPOSITE SILICA | 0 | 0 | 0 |
| | | | (3 μm) | | | |
| | | B2d | TRANSPARENT ACRYLIC | 0 | 0 | 0 |
| | | | BEADS (3 μm) | | | |
| | | B2e | TRANSPARENT ACRYLIC | 0 | 0 | 0 |
| | | | BEADS (2 μm) | | | |

| | ※A:B = 1:• (MASS RATIO) | | 11.7 | 13.8 | 14.2 |
|---|---|---|---|---|---|
| | ※(A + B + D):B = 100:• | | 87.5 | 89.2 | 89.5 |
| | (MASS RATIO) | | | | |
| C | C1 | METHYL ETHYL | 1600 | 1900 | 1950 |
| | | KETONE | | | |
| | C2 | BUTYL ACETATE | 1600 | 1900 | 1950 |

| | TOTAL SOLID CONTENT (%) | | | 20 | 20 | 20 |
|---|---|---|---|---|---|---|
| CHARACTERISTIC | | PAINT | VISCOSITY 1 | ◯ | ◯ | ◯ |
| EVALUATION | | | INJECTION PERFORMANCE | ◯ | ◯ | ◯ |
| | | | APPLICABILITY 1 | ◯ | ◯ | ◯ |
| | | | (SPRAY COATING) | | | |
| | | | LIQUID DRIPPING | ◯ | ◯ | ◯ |
| | | | CHARACTERISTIC | | | |
| | | MEMBRANE | GLOSSINESS (SPECULAR | ⊚ | ⊚ | ⊚ |
| | | CHARACTERISTICS | GLOSSINESS AT 60°) | | | |
| | | | REFLECTANCE (550 | ◯ | ◯ | ◯ |
| | | | nm REFLECTANCE) | | | |
| | | | L VALUE (L* VALUE IN | ◯ | ◯ | ◯ |
| | | | CIELAB COLOR SPACE SYSTEM) | | | |
| | | | LIGHT-SHIELDING | ⊚ | ⊚ | ⊚ |
| | | | CHARACTERISTIC | | | |
| | | | ADHESIVENESS | ⊚ | ◯ | Δ |
| | | | ABRASION RESISTANCE 1 | ◯ | Δ | X |
| | | | ABRASION RESISTANCE 2 | ◯ | Δ | X |
| | | | ※COMPREHENSIVE | ◯ | ◯ | X |
| | | | EVALUATION | | | |

TABLE 2

| | | | | | | EXPERIMENTAL EXAMPLES | | |
|---|---|---|---|---|---|---|---|---|
| | | COMPONENTS | | | | 5a | 6a | 7a |
| PAINT | COMPOSITION | A | A1 | A1a | BL-S | 0 | 0 | 0 |
| COMPOSITION | | | | A1b | BM-S(Z) | 60 | 60 | 60 |
| | | | | A1c | BH-S | 0 | 0 | 0 |
| | | | | A1d | BX-5(Z) | 0 | 0 | 0 |
| | | | | A1e | KS-5Z | 0 | 0 | 0 |
| | | | OTHER | A2 | A801 | 0 | 0 | 0 |
| | | | THAN A1 | | | | | |

| D | D1 | | ISOCYANATE COMPOUND | 40 | 40 | 40 |
|---|---|---|---|---|---|---|
| B | B1 | B1a | BLACK ACRYLIC | 600 | 0 | 0 |
| | OTHER | | BEADS (3-5 μm) | | | |
| | THAN B1 | B2a | BLACK ACRYLIC | 0 | 600 | 0 |
| | | | BEADS (14-16 μm) | | | |
| | | B2b | CARBON BLACK | 0 | 0 | 500 |
| | | | (150 nm) | | | |
| | | B2c | COMPOSITE | 0 | 0 | 0 |
| | | | SILICA (3 μm) | | | |
| | | B2d | TRANSPARENT ACRYLIC | 0 | 0 | 0 |
| | | | BEADS (3 μm) | | | |
| | | B2e | TRANSPARENT ACRYLIC | 0 | 0 | 0 |
| | | | BEADS (2 μm) | | | |

| | ※A:B = 1:• (MASS RATIO) | | 10.0 | 10.0 | 10.0 |
|---|---|---|---|---|---|
| | ※(A + B + D):B = 100:• | | 85.7 | 85.7 | 85.7 |
| | (MASS RATIO) | | | | |
| C | C1 | METHYL ETHYL | 900 | 900 | 900 |
| | | KETONE | | | |
| | C2 | BUTYL ACETATE | 900 | 900 | 900 |

| | TOTAL SOLID CONTENT (%) | | | 28 | 28 | 28 |
|---|---|---|---|---|---|---|
| CHARACTERISTIC | | PAINT | VISCOSITY 2 | ◯ | ◯ | ◯ |
| EVALUATION | | | APPLICABILITY 2 | ◯ | ◯ | ◯ |
| | | | (BRUSH PAINTING) | | | |
| | | MEMBRANE | GLOSSINESS (SPECULAR | ⊚ | ⊚ | X |
| | | CHARACTERISTIC | GLOSSINESS AT 60°) | | | |
| | | | REFLECTANCE (550 | ◯ | X | ⊚ |
| | | | nm REFLECTANCE) | | | |
| | | | L VALUE (L* VALUE IN | ◯ | X | ⊚ |
| | | | CIELAB COLOR SPACE SYSTEM) | | | |
| | | | LIGHT-SHIELDING | ⊚ | X | ⊚ |
| | | | CHARACTERISTIC | | | |
| | | | ADHESIVENESS | ⊚ | ⊚ | X |
| | | | ABRASION RESISTANCE 1 | ◯ | ◯ | X |
| | | | ABRASION RESISTANCE 2 | ◯ | ◯ | X |
| | | | ※COMPREHENSIVE | ◯ | X | X |
| | | | EVALUATION | | | |

| | | | | | | EXPERIMENTAL EXAMPLES | | | |
|---|---|---|---|---|---|---|---|---|---|
| | | COMPONENTS | | | | 8a | | 9a | |
| PAINT | COMPOSITION | A | A1 | A1a | BL-S | 0 | | 0 | |
| COMPOSITION | | | | A1b | BM-S(Z) | 60 | | 60 | |
| | | | | A1c | BH-S | 0 | | 0 | |
| | | | | A1d | BX-5(Z) | 0 | | 0 | |
| | | | | A1e | KS-5Z | 0 | | 0 | |
| | | | OTHER | A2 | A801 | 0 | | 0 | |
| | | | THAN A1 | | | | | | |
| | | D | D1 | | ISOCYANATE COMPOUND | 40 | | 40 | |
| | | B | B1 | B1a | BLACK ACRYLIC | 0 | | 0 | |
| | | | OTHER | | BEADS (3-5 μm) | | | | |
| | | | THAN B1 | B2a | BLACK ACRYLIC | 0 | | 0 | |
| | | | | | BEADS (14-16 μm) | | | | |
| | | | | B2b | CARBON BLACK | 0 | | 0 | |
| | | | | | (150 nm) | | | | |
| | | | | B2c | COMPOSITE | 600 | | 0 | |
| | | | | | SILICA (3 μm) | | | | |
| | | | | B2d | TRANSPARENT ACRYLIC | 0 | | 600 | |
| | | | | | BEADS (3 μm) | | | | |
| | | | | B2e | TRANSPARENT ACRYLIC | 0 | | 0 | |
| | | | | | BEADS (2 μm) | | | | |
| | | | ※A:B = 1:• (MASS RATIO) | | | 10.0 | | 10.0 | |
| | | | ※(A + B + D):B = 100:• | | | 85.7 | | 85.7 | |
| | | | (MASS RATIO) | | | | | | |
| | | C | C1 | | METHYL ETHYL | 900 | | 900 | |
| | | | | | KETONE | | | | |
| | | | C2 | | BUTYL ACETATE | 900 | | 900 | |
| | TOTAL SOLID CONTENT (%) | | | | | 28 | | 28 | |
| CHARACTERISTIC | | PAINT | VISCOSITY 2 | | | ◯ | | ◯ | |
| EVALUATION | | | APPLICABILITY 2 | | | ◯ | | ◯ | |
| | | | (BRUSH PAINTING) | | | | | | |
| | | MEMBRANE | GLOSSINESS (SPECULAR | | | ⊚ | | ⊚ | |
| | | CHARACTERISTIC | GLOSSINESS AT 60°) | | | | | | |
| | | | REFLECTANCE (550 | | | X | | X | |
| | | | nm REFLECTANCE) | | | | | | |
| | | | L VALUE (L* VALUE IN | | | Δ | | X | |
| | | | CIELAB COLOR SPACE SYSTEM) | | | | | | |
| | | | LIGHT-SHIELDING | | | ⊚ | | X | |
| | | | CHARACTERISTIC | | | | | | |
| | | | ADHESIVENESS | | | X | | ◯ | |
| | | | ABRASION RESISTANCE 1 | | | X | | ◯ | |
| | | | ABRASION RESISTANCE 2 | | | X | | ◯ | |
| | | | ※COMPREHENSIVE | | | X | | X | |
| | | | EVALUATION | | | | | | |
| | | | | | | EXPERIMENTAL EXAMPLES | | | |
| | | COMPONENTS | | | | 10a | 11a | 12a | 13a |
| PAINT | COMPOSITION | A | A1 | A1a | BL-S | 0 | 0 | 0 | 0 |
| COMPOSITION | | | | A1b | BM-S(Z) | 60 | 60 | 60 | 60 |
| | | | | A1c | BH-S | 0 | 0 | 0 | 0 |
| | | | | A1d | BX-5(Z) | 0 | 0 | 0 | 0 |
| | | | | A1e | KS-5Z | 0 | 0 | 0 | 0 |
| | | | OTHER | A2 | A801 | 0 | 0 | 0 | 0 |
| | | | THAN A1 | | | | | | |

| D | D1 | | ISOCYANATE COMPOUND | 40 | 40 | 40 | 40 |
|---|---|---|---|---|---|---|---|
| B | B1 | B1a | BLACK ACRYLIC | 0 | 410 | 490 | 550 |
| | OTHER | | BEADS (3-5 μm) | | | | |
| | THAN B1 | B2a | BLACK ACRYLIC | 0 | 0 | 0 | 0 |
| | | | BEADS (14-16 μm) | | | | |
| | | B2b | CARBON BLACK | 0 | 0 | 0 | 0 |
| | | | (150 nm) | | | | |
| | | B2c | COMPOSITE | 0 | 0 | 0 | 0 |
| | | | SILICA (3 μm) | | | | |
| | | B2d | TRANSPARENT ACRYLIC | 0 | 0 | 0 | 0 |
| | | | BEADS (3 μm) | | | | |
| | | B2e | TRANSPARENT ACRYLIC | 600 | 0 | 0 | 0 |
| | | | BEADS (2 μm) | | | | |

| | ※A:B = 1:• (MASS RATIO) | | 10.0 | 6.8 | 8.2 | 9.2 |
|---|---|---|---|---|---|---|
| | ※(A + B + D):B = 100:• | | 85.7 | 80.4 | 83.1 | 84.6 |
| | (MASS RATIO) | | | | | |
| C | C1 | METHYL ETHYL | 900 | 650 | 770 | 850 |
| | | KETONE | | | | |
| | C2 | BUTYL ACETATE | 900 | 650 | 770 | 850 |

| | TOTAL SOLID CONTENT (%) | | | 28 | 28 | 28 | 28 |
|---|---|---|---|---|---|---|---|
| CHARACTERISTIC | | PAINT | VISCOSITY 2 | ◯ | ◯ | ◯ | ◯ |
| EVALUATION | | | APPLICABILITY 2 | ◯ | ◯ | ◯ | ◯ |
| | | | (BRUSH PAINTING) | | | | |
| | | MEMBRANE | GLOSSINESS (SPECULAR | ⊚ | ⊚ | ⊚ | ⊚ |
| | | CHARACTERISTIC | GLOSSINESS AT 60°) | | | | |
| | | | REFLECTANCE (550 | X | X | Δ | ◯ |
| | | | nm REFLECTANCE) | | | | |
| | | | L VALUE (L* VALUE IN | X | Δ | ◯ | ◯ |
| | | | CIELAB COLOR SPACE SYSTEM) | | | | |
| | | | LIGHT-SHIELDING | X | ◯ | ⊚ | ⊚ |
| | | | CHARACTERISTIC | | | | |
| | | | ADHESIVENESS | ◯ | ◯ | ⊚ | ⊚ |
| | | | ABRASION RESISTANCE 1 | ◯ | ◯ | ◯ | ◯ |
| | | | ABRASION RESISTANCE 2 | ◯ | ◯ | ◯ | ◯ |
| | | | ※COMPREHENSIVE | X | X | ◯ | ◯ |
| | | | EVALUATION | | | | |

| | | | | | | EXPERIMENTAL EXAMPLES | | | |
|---|---|---|---|---|---|---|---|---|---|
| | | COMPONENTS | | | | 5a | 14a | 15a | 16a |
| PAINT | COMPOSITION | A | A1 | A1a | BL-S | 0 | 0 | 0 | 0 |
| COMPOSITION | | | | A1b | BM-S(Z) | 60 | 60 | 60 | 60 |
| | | | | A1c | BH-S | 0 | 0 | 0 | 0 |
| | | | | A1d | BX-5(Z) | 0 | 0 | 0 | 0 |
| | | | | A1e | KS-5Z | 0 | 0 | 0 | 0 |
| | | | OTHER | A2 | A801 | 0 | 0 | 0 | 0 |
| | | | THAN | | | | | | |
| | | | A1 | | | | | | |

| D | D1 | | ISOCYANATE | 40 | 40 | 40 | 40 |
|---|---|---|---|---|---|---|---|
| | | | COMPOUND | | | | |
| B | B1 | B1a | BLACK | 600 | 700 | 830 | 850 |
| | | | ACRYLIC | | | | |
| | OTHER | | BEADS (3-5 μm) | | | | |
| | THAN | B2a | BLACK | 0 | 0 | 0 | 0 |
| | B1 | | ACRYLIC | | | | |
| | | | BEADS | | | | |
| | | | (14-16 μm) | | | | |
| | | B2b | CARBON BLACK | 0 | 0 | 0 | 0 |
| | | | (150 nm) | | | | |
| | | B2c | COMPOSITE | 0 | 0 | 0 | 0 |
| | | | SILICA (3 μm) | | | | |
| | | B2d | TRANSPARENT | 0 | 0 | 0 | 0 |
| | | | ACRYLIC | | | | |
| | | | BEADS (3 μm) | | | | |
| | | B2e | TRANSPARENT | 0 | 0 | 0 | 0 |
| | | | ACRYLIC | | | | |
| | | | BEADS (2 μm) | | | | |

| | ※A:B = 1:• | | 10.0 | 11.7 | 13.8 | 14.2 |
|---|---|---|---|---|---|---|
| | (MASS RATIO) | | | | | |
| | ※(A + B + D):B = | | 85.7 | 87.5 | 89.2 | 89.5 |
| | 100:• (MASS RATIO) | | | | | |
| C | C1 | METHYL ETHYL | 900 | 1050 | 1200 | 1250 |
| | | KETONE | | | | |
| | C2 | BUTYL ACETATE | 900 | 1050 | 1200 | 1250 |

| | TOTAL SOLID CONTENT (%) | | | 28 | 28 | 28 | 28 |
|---|---|---|---|---|---|---|---|
| CHARACTERISTIC | | PAINT | VISCOSITY 2 | ◯ | ◯ | ◯ | ◯ |
| EVALUATION | | | APPLICABILITY 2 | ◯ | ◯ | ◯ | ◯ |
| | | | (BRUSH PAINTING) | | | | |
| | | MEMBRANE | GLOSSINESS (SPECULAR | ⊚ | ⊚ | ⊚ | ⊚ |
| | | CHARACTERISTIC | GLOSSINESS AT 60°) | | | | |
| | | | REFLECTANCE (550 | ◯ | ◯ | ◯ | ◯ |
| | | | nm REFLECTANCE) | | | | |
| | | | L VALUE (L* VALUE IN | ◯ | ◯ | ◯ | ◯ |
| | | | CIELAB COLOR SPACE SYSTEM) | | | | |
| | | | LIGHT-SHIELDING | ⊚ | ⊚ | ⊚ | ⊚ |
| | | | CHARACTERISTIC | | | | |
| | | | ADHESIVENESS | ⊚ | ⊚ | ◯ | Δ |
| | | | ABRASION RESISTANCE 1 | ◯ | ◯ | Δ | X |
| | | | ABRASION RESISTANCE 2 | ◯ | ◯ | Δ | X |
| | | | ※COMPREHENSIVE | ◯ | ◯ | ◯ | X |
| | | | EVALUATION | | | | |

TABLE 3

| | | | | | | EXPERIMENTAL EXAMPLES | | |
|---|---|---|---|---|---|---|---|---|
| | | COMPONENTS | | | | 17 | 5 | 18 |
| PAINT | COMPOSITION | A | A1 | A1a | BL-S | 60 | 0 | 0 |
| COMPOSITION | | | | A1b | BM-S(Z) | 0 | 60 | 0 |
| | | | | A1c | BH-S | 0 | 0 | 60 |
| | | | | A1d | BX-5(Z) | 0 | 0 | 0 |
| | | | | A1e | KS-5Z | 0 | 0 | 0 |
| | | | OTHER | A2 | A801 | 0 | 0 | 0 |
| | | | THAN A1 | | | | | |

| D | D1 | | ISOCYANATE | 40 | 40 | 40 |
|---|---|---|---|---|---|---|
| | | | COMPOUND | | | |
| B | B1 | B1a | BLACK | 600 | 600 | 600 |
| | | | ACRYLIC | | | |
| | | | BEADS (3-5 μm) | | | |
| | OTHER | B2a | BLACK | 0 | 0 | 0 |
| | THAN B1 | | ACRYLIC | | | |
| | | | BEADS (14-16 μm) | | | |
| | | B2b | CARBON | 0 | 0 | 0 |
| | | | BLACK | | | |
| | | | (150 nm) | | | |
| | | B2c | COMPOSITE | 0 | 0 | 0 |
| | | | SILICA (3 μm) | | | |
| | | B2d | TRANSPARENT | 0 | 0 | 0 |
| | | | ACRYLIC | | | |
| | | | BEADS (3 μm) | | | |
| | | B2e | TRANSPARENT | 0 | 0 | 0 |
| | | | ACRYLIC | | | |
| | | | BEADS (2 μm) | | | |

| | ※A:B = 1:• | | 10.0 | 10.0 | 10.0 |
|---|---|---|---|---|---|
| | (MASS RATIO) | | | | |
| | ※(A + B + D):B = | | 85.7 | 85.7 | 85.7 |
| | 100:• (MASS RATIO) | | | | |
| C | C1 | METHYL ETHYL | 1400 | 1400 | 1400 |
| | | KETONE | | | |
| | C2 | BUTYL ACETATE | 1400 | 1400 | 1400 |

| | TOTAL SOLID CONTENT (%) | | | 20 | 20 | 20 |
|---|---|---|---|---|---|---|
| CHARACTERISTIC | | PAINT | VISCOSITY 1 | ◯ | ◯ | ◯ |
| EVALUATION | | | INJECTION PERFORMANCE | ◯ | ◯ | ◯ |
| | | | APPLICABILITY 1 | ◯ | ◯ | ◯ |
| | | | (SPRAY COATING) | | | |
| | | | LIQUID DRIPPING | ◯ | ◯ | ◯ |
| | | | CHARACTERISTIC | | | |
| | | MEMBRANE | GLOSSINESS (SPECULAR | ⊚ | ⊚ | ⊚ |
| | | CHARACTERISTICS | GLOSSINESS AT 60°) | | | |
| | | | REFLECTANCE | ◯ | ◯ | ◯ |
| | | | (550 nm REFLECTANCE) | | | |
| | | | L VALUE (L* VALUE | ◯ | ◯ | ◯ |
| | | | IN CIELAB COLOR | | | |
| | | | SPACE SYSTEM) | | | |
| | | | LIGHT-SHIELDING | ⊚ | ⊚ | ⊚ |
| | | | CHARACTERISTIC | | | |
| | | | ADHESIVENESS | ⊚ | ⊚ | ⊚ |
| | | | ABRASION RESISTANCE 1 | ◯ | ◯ | ◯ |
| | | | ABRASION RESISTANCE 2 | ◯ | ◯ | ◯ |
| | | | ※COMPREHENSIVE | ◯ | ◯ | ◯ |
| | | | EVALUATION | | | |

| | | | | | | EXPERIMENTAL EXAMPLES | |
|---|---|---|---|---|---|---|---|
| | | COMPONENTS | | | | 19 | 20 |
| PAINT | COMPOSITION | A | A1 | A1a | BL-S | 0 | 0 |
| COMPOSITION | | | | A1b | BM-S(Z) | 0 | 0 |
| | | | | A1c | BH-S | 0 | 0 |
| | | | | A1d | BX-5(Z) | 60 | 0 |
| | | | | A1e | KS-5Z | 0 | 60 |
| | | | OTHER | A2 | A801 | 0 | 0 |
| | | | THAN A1 | | | | |

| D | D1 | | ISOCYANATE | 40 | 40 |
|---|---|---|---|---|---|
| | | | COMPOUND | | |
| B | B1 | B1a | BLACK | 600 | 600 |
| | | | ACRYLIC | | |
| | | | BEADS (3-5 μm) | | |
| | OTHER | B2a | BLACK | 0 | 0 |
| | THAN B1 | | ACRYLIC | | |
| | | | BEADS (14-16 μm) | | |
| | | B2b | CARBON | 0 | 0 |
| | | | BLACK | | |
| | | | (150 nm) | | |
| | | B2c | COMPOSITE | 0 | 0 |
| | | | SILICA (3 μm) | | |
| | | B2d | TRANSPARENT | 0 | 0 |
| | | | ACRYLIC | | |
| | | | BEADS (3 μm) | | |
| | | B2e | TRANSPARENT | 0 | 0 |
| | | | ACRYLIC | | |
| | | | BEADS (2 μm) | | |

| | ※A:B = 1:• | | 10.0 | 10.0 |
|---|---|---|---|---|
| | (MASS RATIO) | | | |
| | ※(A + B + D):B = | | 85.7 | 85.7 |
| | 100:• (MASS RATIO) | | | |
| C | C1 | METHYL ETHYL | 1400 | 1400 |
| | | KETONE | | |
| | C2 | BUTYL ACETATE | 1400 | 1400 |

| | TOTAL SOLID CONTENT (%) | | | 20 | 20 |
|---|---|---|---|---|---|
| CHARACTERISTIC | | PAINT | VISCOSITY 1 | ◯ | ◯ |
| EVALUATION | | | INJECTION PERFORMANCE | ◯ | ◯ |
| | | | APPLICABILITY 1 | ◯ | ◯ |
| | | | (SPRAY COATING) | | |
| | | | LIQUID DRIPPING | ◯ | ◯ |
| | | | CHARACTERISTIC | | |
| | | MEMBRANE | GLOSSINESS (SPECULAR | ⊚ | ⊚ |
| | | CHARACTERISTICS | GLOSSINESS AT 60°) | | |
| | | | REFLECTANCE | ◯ | ◯ |
| | | | (550 nm REFLECTANCE) | | |
| | | | L VALUE (L* VALUE | ◯ | ◯ |
| | | | IN CIELAB COLOR | | |
| | | | SPACE SYSTEM) | | |
| | | | LIGHT-SHIELDING | ⊚ | ⊚ |
| | | | CHARACTERISTIC | | |
| | | | ADHESIVENESS | ⊚ | ⊚ |
| | | | ABRASION RESISTANCE 1 | ⊚ | ⊚ |
| | | | ABRASION RESISTANCE 2 | ⊚ | ⊚ |
| | | | ※COMPREHENSIVE | ◯ | ◯ |
| | | | EVALUATION | | |

### 4. Consideration

As shown in Table 1, in the case where (A1) was not included as (A) in a composition contained in a paint (Experimental examples 1 to 4), one or more of glossiness, reflectance, an L value, adhesiveness and abrasion resistances 1 and 2, which are membrane characteristics, was not satisfied. Even if (A1) was included as (A) in a composition (Experimental examples 5 to 10), when (B1) having a particle diameter in a predetermined range was not included in (B) (Experimental examples 6 to 10), one or more of glossiness, reflectance, an L value, adhesiveness and abrasion resistances 1 and 2 was not satisfied. Even if (B1) having a particle diameter in a predetermined range was included in (B) (Experimental examples 5 and 11 to 16), when a mass ratio of a resin solid content of (B) with respect to a resin solid content of (A):1 was less than 7 (Experimental example 11) or exceeds 14 (Experimental example 16), one or more of glossiness, reflectance, an L value, adhesiveness and at least one of abrasion resistances 1 and 2 was not satisfied.

On the other hand, when a mass ratio of (B) with respect to a resin solid content of (A):1 was also proper (7 or more and 14 or less) (Experimental examples 5 and 12 to 15), the characteristics of a paint and membrane characteristics were all satisfied.

As shown in Table 2, even if (A1) is included as (A) in a composition contained in a paint, (Experimental examples 5a to 10a), when (B1) having a particle diameter in a predetermined range was not included in (B) (Experimental examples 6a to 10a), one or more of glossiness, reflectance, an L value, adhesiveness and abrasion resistances 1 and 2 was not satisfied. Even if (B1) having a particle diameter in a predetermined range was included in (B) (Experimental examples 5a and 11a to 16a), a mass ratio of (B) with respect to a resin solid content of (A):1 is less than 7 (Experimental example 11a) or exceeds 14 (Experimental example 16a), one or more of glossiness, reflectance, an L value, adhesiveness and at least one of abrasion resistances 1 and 2 was not satisfied.

On the other hand, when a mass ratio of (B) with respect to a resin solid content of (A):1 was proper (7 or more and 14 or less) (Experimental examples 5a and 12a to 15a), all of the paint characteristics and the membrane characteristics were satisfied.

As shown in Table 3, when fixing an amount of (A) and changing a kind of (A1) (Experimental examples 5 and 17 to 20), it was observed that the membrane strength (pencil hardness and abrasion resistances) improved with increasing molecular weight and glass transition temperature.

### Experimental Example 21

As a black material, except that black acrylic beads having a little large particle diameter (a particle diameter of 5 to 6 μm), which was a spheric acrylic resin particle containing CB as same as in B1a, was used in place of B1a, a paint having an identical composition with that in Experimental example 5 was prepared. Then, a membrane was formed in the same way as above and the same evaluations were made. It was confirmed that the same evaluation results as in Experimental example 5 were obtained.

1. A resin composition for a paint, comprising at least (A) and (B): wherein
(A) comprises (A1), wherein an amount of (A1) in 100% by mass of (A) is 90% by mass or more;
(B) comprises (B1) having a particle diameter of 2 μm or more and 6 μm or less, wherein an amount of (B1) in 100% by mass of (B) is 90% by mass or more;
a mass ratio of (B) with respect to (A):1 is 7 or more and 14 or less;
(A) is a resin component;
(A1) is a polyvinyl acetal resin;
(B) is a black material; and
(B1) is a composite of a black pigment and a resin.

2. The resin composition according to claim 1, wherein (B1) comprises an acrylic resin particle containing carbon black therein.

3. A paint comprising the resin composition according to claim 1 and (C):
wherein viscosity at 25° C. measured by a B-type viscometer is 1 mPa·s or more and 2000 mPa·s or less; and
(C) is a diluting solvent.

4. The paint according to claim 3, used for applying to model parts.

5. The paint according to claim 3, used for applying to camera parts.

6. The paint according to claim 3, used for applying in a spray coating method, wherein viscosity at 25° C. measured by a B-type viscometer is 1 mPa·s or more and 50 mPa·s or less.

7. The paint according to claim 3, used for applying in a dip coating method, wherein viscosity at 25° C. measured by a B-type viscometer is 20 mPa·s or more and 500 mPa·s or less.

8. The paint according to claim 3, used for applying in a dispenser method, wherein viscosity at 25° C. measured by a B-type viscometer is 10 mPa·s or more and 300 mPa·s or less.

9. The paint according to claim 3, used for applying in a brush painting method, wherein viscosity at 25° C. measured by a B-type viscometer is 100 mPa·s or more and 2000 mPa·s or less.

10. A membrane formed from the paint according to claim 3, wherein an outermost surface of a plane formed with the membrane has glossiness of less than 1% against an incident light at an angle of 60°, reflectance of less than 1.5% against a light having a wavelength of 550 nm, and an L value of less than 15 in the CIELAB color space system by the SCE method.

11. The membrane according to claim 10, wherein an outermost surface of a plane formed with the membrane has an optical density of 2 or more in the case where a light-shielding characteristic when transmitting a light is required to the membrane.

12. A paint comprising the resin composition according to claim 2 and (C):
wherein viscosity at 25° C. measured by a B-type viscometer is 1 mPa·s or more and 2000 mPa·s or less; and
(C) is a diluting solvent.

13. A membrane formed from the paint according to claim 12, wherein an outermost surface of a plane formed with the membrane has glossiness of less than 1% against an incident light at an angle of 60°, reflectance of less than 1.5% against a light having a wavelength of 550 nm, and an L value of less than 15 in the CIELAB color space system by the SCE method.

14. The membrane according to claim 13, wherein an outermost surface of a plane formed with the membrane has an optical density of 2 or more in the case where a light-shielding characteristic when transmitting a light is required to the membrane.

15. The resin composition according to claim 1, wherein a form of a composite of the black pigment and the resin in (B1) is any of (1) a form of covering the black pigment with the resin, (2) a form of bonding the resin with a surface or inside of the black pigment, and (3) a form of adhering the resin to a surface or inside of the black pigment.

16. The resin composition according to claim 1, wherein (B1) comprises a resin particle containing the black pigment therein.

17. The resin composition according to claim 1, wherein (B) consists of (B1) having a particle diameter of 2 μm or more and 6 μm or less.

18. The resin composition according to claim 1, further comprising a curing agent of (A1).
